(19) United States
(12) Patent Application Publication
(10) Pub. No.: US 2022/0179193 A1
(43) Pub. Date: Jun. 9, 2022

(54) FOUR-DIMENSIONAL ENERGY DIRECTING SYSTEMS AND METHODS

(71) Applicant: Light Field Lab, Inc., San Jose, CA (US)

(72) Inventors: Brendan Elwood Bevensee, San Jose, CA (US); Jonathan Sean Karafin, San Jose, CA (US)

(21) Appl. No.: 17/600,825

(22) PCT Filed: Apr. 2, 2020
(86) PCT No.: PCT/US2020/026486

§ 371 Date: Oct. 1, 2021

Related U.S. Application Data
(60) Provisional application No. 62/828,390, filed on Apr. 2, 2019.

(51) Int. Cl. G02B 26/08; G02B 26/10; G02B 1/00; G02B 27/09

(52) U.S. Cl. CPC G02B 26/085; G02B 26/101; H01F 7/081; G02B 27/0972; G02B 1/002

(57) ABSTRACT

An energy directing system may include one or more energy sources and a plurality of energy directing surfaces configured to direct incident energy along a plurality of energy propagation paths therefrom. The plurality of energy directing surfaces are arranged such that the energy propagation paths from each energy directing surface are each defined by a four-dimensional coordinate, the four-dimensional coordinate comprising two spatial coordinates corresponding to a location of the respective energy directing surface and two angular coordinates defining the angular direction of the respective propagation path. Energy attribute data may be used to determine instructions for operating the one or more energy sources and the energy directing surfaces.

### TECHNICAL FIELD

This disclosure is related to energy directing systems, and specifically to energy directing systems with energy directing surfaces arranged and configured to direct energy in a four-dimensional coordinate system.

### BACKGROUND

The dream of an interactive virtual world within a “holodeck” chamber as popularized by Gene Roddenberry's Star Trek and originally envisioned by author Alexander Moszkowski in the early 1900s has been the inspiration for science fiction and technological innovation for nearly a century. However, no compelling implementation of this experience exists outside of literature, media, and the collective imagination of children and adults alike. The present application teaches systems and methods to render information from a 3D environment into a format to allow a 4D energy-field projection system to output a 4D energy field modeled on the a scene from the 3D environment.

### SUMMARY

An energy field is a vector function which describes the flow of energy in a plurality of directions at a plurality of points in space. An energy directing system may comprise a plurality of energy directing surfaces where energy is directed in multiple directions with varying energy attributes. Each physical location of the energy directing surface has a two-dimensional (“2D”) spatial coordinate (x, y), and each direction of the output energy propagation paths is described in three-dimensional (“3D”) space by two angular coordinates (ϑ, φ), or equivalently the normalized coordinates (u, v). Together, the 2D spatial coordinates (x, y) and the 2D angular coordinates form a 4D coordinate (x, y, ϑ, φ), where each ray of energy propagation is described by a location and an angle of energy projection from that location.

It is possible to direct energy along a sequence of energy propagation paths from a fixed location by deflecting a beam of energy with the energy-directing surface configured to implement a constant or continuous change in the pointing of the energy in the angular coordinates ϑ and φ.

An embodiment of an energy directing system in accordance with the principles of the present disclose includes 1) a plurality of energy sources; 2) a plurality of energy directing surfaces configured to each receive energy from at least one energy source of the plurality of energy sources and direct energy along a plurality of energy propagation paths therefrom; and 3) a controller in communication with the plurality of energy sources and the plurality of energy directing surfaces, the controller operable to provide synchronized signals to the energy sources and the energy directing surfaces to selectively direct energy along different energy propagation paths. The plurality of energy directing surfaces are arranged such that the energy propagation paths from each energy directing surface are each defined by a four-dimensional coordinate, the four-dimensional coordinate comprising two spatial coordinates corresponding to a location of the respective energy directing surface and two angular coordinates defining the angular direction of the respective propagation path.

An embodiment of an energy directing system in accordance with the principles of the present disclose includes 1) an energy source configured to provide collimated energy; 2) an array of energy directing surfaces each configured to receive the collimated energy and deflect the received energy along a plurality of energy propagation paths therefrom; and 3) a controller in communication with the energy directing surfaces, the controller operable to provide signals to the energy directing surfaces to selectively direct energy along different energy propagation paths. The plurality of energy directing surfaces are arranged in the array such that the energy propagation paths from each energy directing surface are each defined by a four-dimensional coordinate, the four-dimensional coordinate comprising two spatial coordinates corresponding to a location of the respective energy directing surface and two angular coordinates defining the angular direction of the respective propagation path.

An embodiment of a method for directing energy according to a four-dimensional function in accordance with the principles of the present disclose includes the steps of: 1) receiving a data set comprising energy attribute data for a plurality of four-dimensional (“4D”) coordinates in a 4D coordinate system, the plurality of 4D coordinates each comprising two spatial coordinates defining spatial locations of a plurality of energy directing surfaces in the 4D coordinate system, the plurality of energy directing surfaces configured to each receive energy from one or more energy sources and direct the energy along a plurality of energy propagation paths therefrom and two angular coordinates defining the angular directions of the energy propagation paths from each energy directing surface; 2) processing the data set into subsets of data, each subset of data comprising the energy attribute data for the two angular coordinates of the energy propagation paths having the same two spatial coordinates in the 4D coordinate system; 3) determining, based on a first subset of data, first instructions for operating a first energy directing surface, the instruction comprising a sequence of directing energy along different energy propagation paths of the first energy directing surface, the first subset of data comprising the energy attribute data for the angular coordinates of the energy propagation paths of the first energy directing surface; and 4) operating the first energy directing surface to direct energy in a time-sequential manner according to the determined first instructions.

### BRIEF DESCRIPTION OF THE DRAWINGS

FIG. 1A shows an orthogonal view of an energy-directing device comprised of a configurable reflective metasurface operable to deflect an incident energy along a plurality of propagation paths;

FIG. 1B shows an orthogonal view of an energy-directing device comprised of a configurable transmissive metasurface operable to deflect an incident energy along a plurality of propagation paths;

FIG. 1C shows an orthogonal view of one embodiment of an energy-directing device having a tilting energy reflector which tilts around two axes, shown in a state with zero tilt;

FIG. 1D shows an orthogonal view of the energy-directing system of FIG. 1C with the tilting reflector tilted by an angle ϑ in one axis, and φ in another orthogonal axis;

FIG. 2A is an orthogonal side view of an energy-directing module comprised of an energy source and a configurable energy-directing surface;

FIG. 2B is an orthogonal side view of an energy-directing module comprised of an energy source and a configurable energy-directing surface operable to direct energy along a plurality of energy propagation paths that are arranged about an energy propagation axis which is orthogonal to the module base;

FIG. 2C is an orthogonal side view of an energy-directing module comprised of an energy source and a configurable energy-directing surface operable to direct energy along a plurality of energy propagation paths that are arranged about an energy propagation axis which is not orthogonal to the module base;

FIG. 2D is an orthogonal side view of an energy-directing module comprised of an energy source and a transmissive configurable energy-directing surface of an energy-directing device;

FIG. 2E is an orthogonal side view of an energy-directing module comprised of the energy source and a transmissive configurable energy-directing surface of an energy-directing device, which can deflect the incident energy along energy propagation paths about an energy propagation axis;

FIG. 2F is an orthogonal side view of an energy-directing module which is similar to the energy-directing module shown in FIG. 2E, except a deflection angle for the energy propagation axis which is tilted relative to the normal to the mechanical base of the module;

FIG. 2G is an orthogonal side view of an energy-directing module comprising an energy-directing layer comprised of three transmissive reconfigurable energy-directing sites defined within a common substrate

FIG. 2H is an orthogonal side view of a modular energy source;

FIG. 2I shows an orthogonal view of an energy-directing system with an energy-directing layer comprised of multiple independently controlled energy-directing sites, defined in a single substrate, each deflecting energy from an energy-source module;

FIG. 3A is an orthogonal side view of a modular energy source comprised of a single point-like energy source, and a focusing element;

FIG. 3B shows an orthogonal view of an energy-directing system with an energy-directing device comprised of multiple independently-controlled reconfigurable energy-directing sites, defined in a single substrate and a plurality of energy-source modules;

FIG. 3C is an orthogonal view of an energy directing system comprised of an array of energy-directing modules at a first instance of time t1;

FIG. 3D is the energy directing system shown in FIG. 3C at a second instance of time t2;

FIG. 4A is an orthogonal side view of an energy-directing module which comprises a single point-like energy source and a configurable transmissive energy-directing device which produces collimated and deflected output energy;

FIG. 4B is an orthogonal side view of an energy-directing module which contains a single point-like energy source and a configurable transmissive energy-directing device which produces substantially collimated but slightly focused output energy;

FIG. 4C is an orthogonal side view of an energy-directing module which is comprised of a single point-like energy source and a configurable transmissive energy-directing device which produces energy that are collimated, grouped around an energy projection axis which is tilted relative to a normal to the energy directing surface.

FIG. 5A is a schematic diagram illustrating an operation of a first energy-directing module;

FIG. 5B is a schematic diagram illustrating an implementation of the energy-directing module shown in FIG. 5A;

FIG. 5C is a schematic diagram illustrating an operation of a second energy-directing module;

FIG. 5D is a schematic diagram illustrating an implementation of the energy-directing module shown in FIG. 5C;

FIG. 5E is a schematic diagram illustrating an operation of a third energy-directing module;

FIG. 5F is a schematic diagram illustrating an implementation of the energy-directing module shown in FIG. 5E;

FIG. 6 is a perspective view of one implementation of an energy directing system comprised of an array of eight energy-directing modules, each module comprising an energy-directing device redirecting the energy from a modulated energy source into an energy propagation path;

FIG. 7 is a perspective view of one implementation of an energy directing system comprised of an array of eight energy-directing modules, each module comprising a transmissive reconfigurable energy-directing device redirecting the energy from a modulated energy source into an energy propagation path;

FIG. 8A is a perspective view of one implementation of an energy directing system with an energy-directing layer comprised of multiple independently controlled energy-directing sites, defined in a single substrate, each deflecting energy from an energy-source

FIG. 8B is a perspective view of another implementation of an energy directing system with an energy-directing layer comprised of multiple independently controlled energy-directing sites defined in a single substrate, each energy-directing site deflecting a portion of incident collimated energy;

FIG. 8C is a perspective view of an energy-directing system comprised of an array of 2-axis energy-directing devices which individually reflect portions of incident large-area collimated energy into reflected energy propagation paths;

FIG. 9 is an orthogonal view of one implementation of an energy directing system with an energy-directing layer comprised of multiple independently-controlled energy-directing sites defined in a common substrate, each deflecting a beam of energy from one or more energy sources located on a common backplane into energy propagation paths;

FIG. 10 illustrates an orthogonal view of a light field display system with a variable deflection angle; and

FIG. 11 comprises a flow diagram showing a method for a directing energy with an energy directing system of the present disclosure.

### DETAILED DESCRIPTION

One aspect of the present disclosure relates to embodiments for directing energy in a sequence of energy propagation paths from a fixed location by deflecting energy from an energy source with an energy-directing surface configured to change the direction of the energy propagation paths in the angular coordinates ϑ and φ. One example of such an energy-directing device is a metasurface. Metasurfaces can be used to create flat, compact, and reconfigurable systems which are able to dynamically create an engineered energy wavefront from an incident energy wavefront by spatially arranging nano-scattering elements with various dimensions and a sub-wavelength periodicity. For example, in the optical domain, metasurfaces may include a plurality of sites with subwavelength resolution, which may be dynamically adjusted to manipulate the phase, amplitude, and polarization of incident light, for wavelengths of light that range from the ultraviolet to the infrared wavelengths. An embodiment of these optical metasurfaces may exploit the electrooptical feature of nematic liquid crystals (LC's) to control the phase profile of the metasurfaces, directing energy that is either reflected from a metasurface layer, or transmitted through one or more metasurface layers. The metasurfaces may be reconfigured very quickly, even on the order of microseconds, to achieve rapid scanning through a wide angular range in the two angular coordinates ϑ and φ.

Another example of an energy-directing surface is a micro reflector which tilts in two axes. Such a micro reflector may be a microelectromechanical (MEMS) device, which can be produced using the techniques of microfabrication. The physical dimensions of MEMS devices can vary from well below one micron on the lower end of the dimensional spectrum, up to many millimeters. For example, a MEMS energy reflector, such as a micromirror, may have a reflective surface with a diameter ranging from tens of microns to millimeters, and may rotate by tens of degrees in two orthogonal axes. The MEMS energy reflector may be constructed as a 2D scanning mirror, which may be operable at scanning frequencies of greater than 100 Hz and sometimes over 1000 Hz. The MEMS energy reflectors are durable, as some may tilt by more than a billion times without any considerable wear to any of the moving parts.

Energy may be modulated at a sufficiently high frequency and directed at an energy-directing surface to create a distribution of energy propagation paths. In an embodiment of a scanning mirror projector, light from red, green, and blue lasers (collimated energy sources) may be modulated, combined, and reflected from a mirror that is scanning along two different tilt axes, onto a screen or surface which can be viewed. Due to the persistence of vision, video images may be displayed on the screen or surface for an observer to see. The number of energy propagation paths for this system may be considered equal to the total resolution of the video that is projected. For example, if the resolution of the video is 720p, then the number of discrete energy propagation paths associated with a single location of the micromirror may be the total pixels associated with 720p=1280×720, or 9.2×10⁵. In the context of a four-dimensional (4D) coordinate system, there are 1280 energy propagation path directions in the horizontal angular range ϑ, 720 in the vertical angular range φ, all of which have the same position coordinate (x, y) of the micromirror. An energy-directing system may use many such modules comprised of an energy source such as laser and an energy-deflecting surface such as a micromirror to project many 4D propagation paths per interval of time, wherein the interval of time may be the inverse of a video refresh rate. The energy sources may each be configured to be modulated, and the energy-deflecting surface may only be reconfigured when the corresponding energy source is turned substantially off.

In embodiment of an energy directing system for a 4D light field may be designed to have a high angular resolution which may involve hundreds or thousands of coordinates of angular resolution in u and v for each spatial position. For example, for a 90-degree field of view, and a resolution of 60 energy propagation paths per degree in the horizontal direction, there are 5400 energy propagation paths in the horizontal range of ϑ. Limits on the number of discrete energy propagation paths in the angular range may include the modulation frequency that may be achieved for the energy source, as well as the speed which the energy-directing surface may be reconfigured in a controlled and predictable fashion.

In an embodiment, a 4D energy-directing system allowing for the above discussed technical effects may be constructed to include a plurality of energy sources and a plurality of energy-directing surfaces configured to each receive energy from at least one energy source of the plurality of energy sources and direct energy along a plurality of energy propagation paths therefrom. In an embodiment, the 4D energy-directing system further includes a controller in communication with the plurality of energy sources and the plurality of energy-directing surfaces, the controller operable to provide synchronized signals to the energy sources and the energy-directing surfaces to selectively direct energy along different energy propagation paths. The plurality of energy-directing surfaces may be arranged such that the energy propagation paths from each energy-directing surface are each defined by a four-dimensional coordinate, the four-dimensional coordinate comprising two spatial coordinates, x and y, corresponding to a location of the respective energy-directing surface and two angular coordinate, ϑ and φ, defining the angular direction of the respective propagation path.

The energy directing system of the present disclosure according to the above may be implemented in a variety of ways. In an embodiment, the plurality of energy-directing surfaces and the plurality of energy sources are housed in an array of modular energy-directing modules. The array of energy-directing modules may each comprise an energy-directing surface continuously deflecting energy in multiple directions over a region or volume. In the optical domain, energy modules may be configured to combine separately modulated red, green, and blue lasers into a single beam which is reflected from an integrated scanning mirror that operates fast enough to project video at VGA or higher resolution (e.g. TriLite Technologies, GmbH). Additionally, metasurfaces may be used as an energy-directing surfaces both as transmission devices as well as reflection surface devices.

In an embodiment, rather than using a plurality of energy sources, the present disclosure provides various examples of using an array of energy-directing surfaces, and a single collimated and modulated energy source to implement an energy-directing system.

An energy-directing system may be optimized with the corresponding energy surface projecting energy that is focused within a defined volume. This volume may be a region where holographic objects are generated with converging light rays, tactile surfaces created with ultrasonic energy, etc. An optimized configuration may be one in which the angular range of energy propagation paths from an energy surface is adjusted depending on the location on the energy surface. For example, the optimal range of projection angles near the edge of a light field display may be tilted toward the center of the light field display if the viewing volume is located near the centerline of the display. This disclosure provides various embodiments for configuring the mounting angles of the energy-directing modules to achieve a desired arrangement of energy projection angles from an energy-directing surface.

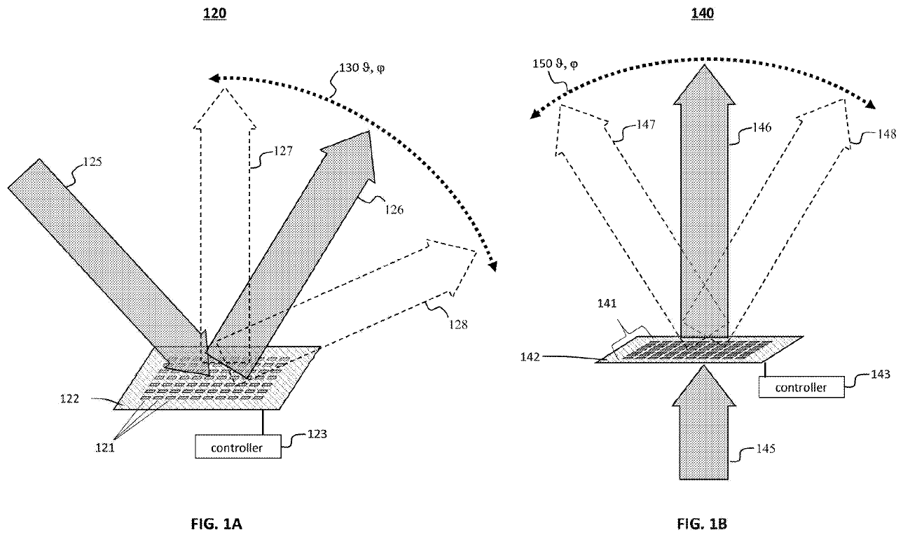

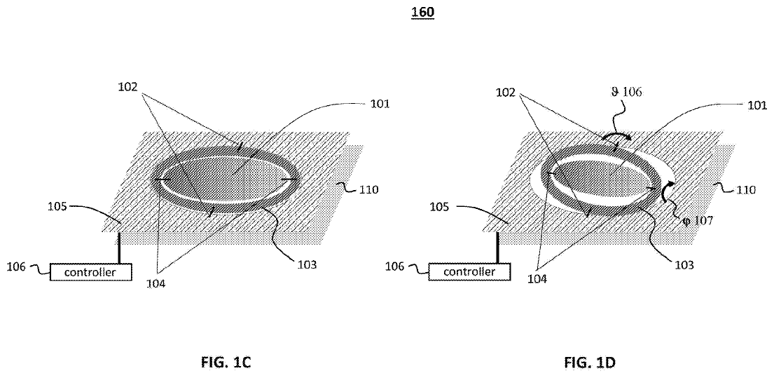

FIG. 1A shows an orthogonal view of an energy-directing surface 120 comprised of a configurable reflective metasurface 122 which contains an active region containing a plurality of nanostructures 121, some of which may be individually controllable by a controller 123, configured to deflect incident energy 125 to one of many possible propagation paths in two orthogonal axes ϑ, φ 130. The metasurface 122 is an energy-directing surface. The nano-structures 121 on metasurface 122 are configured to reflect the incident beam of energy 125 to energy propagation path 126, but the system 120 could be configured to generate many propagation paths in the angular range of axes ϑ, and φ 130, including the illustrated energy propagation paths 127 and 128. The energy-directing system 120 in FIG. 1A is shown deflecting the incident energy 125 to energy propagation paths about one direction (ϑ) in one plane, but it can also deflect energy along propagation paths in the φ direction, orthogonal to ϑ, but these propagation paths are not shown in FIG. 1A. Ultimately, the number of resolvable energy propagation path directions in the two axes is dependent upon the detailed construction of the energy-directing metasurface. In an embodiment, the reconfigurable metasurface 122 is operable to implement a substantially continuous change in the ϑ or φ pointing of the incident energy 125 with increasing time, limited only by the pointing resolution of the system 120. In an embodiment, the pointing of the energy is reconfigurable in less than 10 milliseconds. In another embodiment, the pointing of the energy is configurable in a time between 0.0001 and 1000 microseconds.

The reconfigurable metasurface may include a plurality of dynamically adjustable elements arranged on the surface. In an embodiment, these elements have a plurality of adjustable reflection phases which act to provide a dynamically adjustable reflected or transmitted energy beam in response to incident energy. In an embodiment, the adjustable elements are arranged with inter-element spacing less than the wavelength of the incident energy. In an embodiment, the dynamically adjustable elements contain electrically adjustable material which could be polymer or a liquid crystal material. In an embodiment, each of the plurality of elements further includes a pair of electrodes configured to apply an adjustable voltage across the electrically adjustable material. In an embodiment, the plurality of elements is arranged in a two-dimensional array indexed by row and column, each element is individually addressable, and there may be active control of each element. In an embodiment, the elements are dielectric resonators.

In an embodiment, deflection of both electromagnetic and acoustic energy may be achieved with metamaterials. These metamaterials may include two-dimensional patterned surfaces also called metasurfaces with engineered subwavelength cells or structures that may be used as materials that redirect energy wavefronts. This deflection of incident energy may be done by arranging for graded phase shifts along the profile of the metamaterials. One approach of metasurface design is to effect local phase modulation, which dictates the behavior of outgoing waves according to a generalized Snell's Law (GSL). This may be used to design structures such as lenses and beam splitters. In acoustics, the phase shifts within metasurfaces may be used to manipulate wavefronts and to absorb sounds.

Such approaches have limitations in efficiency of scattering, which may be overcome by using metamaterials that comprise bi-anisotropic materials. In bi-isotropic electromagnetic media, the electric and magnetic fields are coupled by intrinsic constants of the media. If the coupling constants depend on the direction within the media, the media is referred to as bi-anisotropic.

A bi-anisotropic electromagnetic response can be implemented by bi-anisotropic metasurfaces, where the scattered electromagnetic fields are different depending on the direction of illumination. For electromagnetic metasurfaces, solutions may be based on cascaded impedance layers. These structures may deflect light with a high efficiency, focus light, and achieve other optical functionalities. The metamaterials may achieve local phase modulation according to a generalized Snell's law, or have a higher efficiency for deflecting a beam of light by being constructed of structures made of bi-isotropic materials or bi-anisotropic materials. If individual metasurface regions are individually addressable and configurable, an energy-directing angle (φ, ϑ) may be programmed across a range of angles at each of these energy-directing sites.

FIG. 1B shows an orthogonal view of an energy-directing surface 140 comprised of a configurable transmissive metasurface 142 which contains a plurality of individually controlled nanostructures 141 and a controller 143 configured to operate the metasurface 142 to deflect incident energy 145 to one of many possible propagation paths in two axes ϑ, φ 150. The nano-structures 141 on metasurface 142 are configured to both transmit and deflect the incident energy 145 to energy propagation path 146, but the system 140 could be configured to generate any other propagation path in the angular range of ϑ 150, including energy propagation paths 147 and 148. The energy-directing system 140 can also be configured to deflect the incident energy 145 to energy propagation paths about the φ direction, orthogonal to ϑ, but these propagation paths are not shown in FIG. 1B. In an embodiment, the reconfigurable metasurface 142 is operable to implement a continuous change in the or φ pointing of the incident energy 145. In an embodiment, the pointing of the incident energy 145 is reconfigurable in less than 10 milliseconds. In another embodiment, the pointing of the incident energy is configurable in a time between 0.0001 and 1000 microseconds. In an embodiment, the reconfigurable metasurface includes a two-dimensional reconfigurable metasurface.

The reconfigurable metasurfaces shown in FIGS. 1A and 1B may include a plurality of dynamically adjustable elements arranged on the surface. In an embodiment, these elements have a plurality of adjustable reflection or transmission phases which act to provide a dynamically adjustable reflected or transmitted energy in response to incident energy. In an embodiment, the adjustable elements are arranged with inter-element spacing less than the wavelength of the incident energy. In an embodiment, the dynamically adjustable elements contain electrically adjustable material which could be polymer or a liquid crystal material. In an embodiment, each of the plurality of elements further includes a pair of electrodes configured to apply an adjustable voltage across the electrically adjustable material. In an embodiment, a plurality of elements is arranged in a two-dimensional array indexed by row and column. In an embodiment, more than one of the elements are individually addressable by metasurface controller 123 or 143 operable to provide active control of these elements. In an embodiment, the elements are dielectric resonators. In a different embodiment, a metasurface is comprised of a lattice of nanoholes filled with nematic liquid crystal combined with electrical fields to control phase profile of the metasurface and provide beam steering. In one embodiment, the metasurfaces are made of ultra-thin and layered high-index dielectric patches. In one embodiment, the metasurfaces are made of pillar and disk building blocks which are individually designed, constructed, and may be individually addressable. In an embodiment, the reconfigurable metasurface includes a two-dimensional reconfigurable metasurface. In another embodiment, the metasurface has more than one layers of metasurface materials, which may be individually configured. In another embodiment, the metasurface is comprised of bi-isotropic or bi-anisotropic materials.

FIG. 1C shows an orthogonal view of one embodiment of an energy-directing surface 160 implemented with a tilting energy reflector 101 which tilts around two axes, shown in a state with zero tilt. In one embodiment, the energy-directing system 160 comprises a MEMS device. In the embodiment shown in FIG. 1C, the tilting energy reflector energy-directing surface 101, (e.g. a mirror for electromagnetic energy), tilts around a pair of inner flexures 104, which are connected to a gimbal frame 103 which itself tilts on two outer flexures 102 that are connected to a stationary frame 105. The inner pair of flexures and the outer pair of flexures each form an independent orthogonal axis for the energy reflector to tilt. In one embodiment, both pairs of flexures may be torsional hinges, and the tilting energy reflector 101, the flexure pairs 102 and 104 are etched out of a layer of single crystal silicon, which also forms at least a portion of the stationary frame 105. The energy reflector may have a variety of reflective coatings deposited on it, including aluminum, gold, engineered acoustic energy reflectance material, or any other material that is reflective to the appropriate type and wavelength of energy.

FIG. 1D shows an orthogonal view of the energy-directing surface 160 with the reflector 101 tilted by an angle ϑ 106 in one axis, and φ 107 in another orthogonal axis. The gimbal construction ensures that the center of the tiling energy reflector 101 remains stationary as the reflector tilts. The reflector 101 and the stationary frame 105 are both mounted on surface 110, which, in some embodiments, may be a substrate containing integrated electronics including drivers and feedback sensors. In one embodiment, this substrate may be made of silicon with microfabricated components. In another embodiment, the mounting surface 110 may take the form of a printed circuit board (PCB) with electrodes and feedback electronic components such as small LED sources or photodetectors, and the frame of the micromirror 105 may be mounted onto this PCB with spacers.

The energy-directing tilting reflector 101 may be actuated using a variety of methods. Electrostatic actuation may be achieved using a MEMS parallel plate capacitor structure, or a MEMS vertical comb drive actuator with multiple closely spaced parallel plates (neither of these is shown in FIGS. 1C or 1D). A tilting energy reflector 101 with a diameter of a millimeter or larger is particularly well suited to be actuated electromagnetically, since magnetic torque scales with volume for permanent magnetic materials and with coil area for electromagnets. Electromagnetic actuation can be achieved using either one or more coils etched into the tilting energy reflector 101, or permanent magnets attached to the energy reflector 101, and magnetic-field inducing coils which are configured on the surface 110 below the energy reflector 101 to create a push-pull structure on opposite sides of the tilting energy reflector 101. A micro tilting energy reflector may be actuated with other means, including the use of piezoelectric or magnetostrictive materials.

FIGS. 1C and 1D show one possible configuration of the energy-directing tilting energy reflector 101, and it is to be appreciated that many other configurations are possible. For example, in other embodiments, the tilting energy reflector may be implemented as a MEMS device mounted on a post which is attached to a hinge which may be position controlled electrostatically or electromagnetically. Other configurations of tilting energy reflectors are possible as well, including rotating holographic gratings, rotating polygon-shaped mirrors, or combinations of two one-axis tilt solutions such as, but not limited to, a rotating polygon-shaped mirror for one axis (ϑ) and a 1-D scanning mirror for the orthogonal axis (φ).

For some energy directing systems, such as light field displays, energy-directing tilting energy reflectors are similar to scanning mirrors which may be several millimeters in diameter and have a resonant Q-value which is very high. This means that the reflector's tilt response to a step current or voltage will be a tilt step with a large oscillation which may be relatively undamped, taking many milliseconds to die out. For this reason, to enable quick scanning, the MEMS mirrors may be actively controlled using a control circuit which reads the mirror tilt angles at real-time speeds and adjusts the drive current or voltage accordingly. Typically, there are mirror tilt feedback electronic components located on the mounting surface 110 below the mirror surface 101, along with a controller 106 which reads these tilt feedback elements, and calculates the correct electromagnetic drive signals to keep the tilting energy reflector stationary, immune to vibration, or the tilt motion of the tilting energy reflector 101 smooth. In one embodiment, this is done with a PID control loop. In this disclosure, it is assumed that either holding an energy reflector at a fixed tilt angle immune to vibration, or changing the tilt of an energy reflector may both be implemented by running an active control loop which continuously monitors the tilt of the energy reflector and adjusts the drive current or voltage in real time. This control loop may run within the tilt controller 106.

The energy-directing surfaces shown in FIGS. 1A, 1B, 1C, and 1D illustrate compact devices which may be paired with energy sources to create compact energy-directing modules. The energy sources may be collimated, so they form a beam of energy, and modulated, so that they can be temporally controlled to deliver varying amounts of energy at closely spaced intervals of time. A plurality of such energy-directing modules may be used to form an energy-directing surface. In an embodiment, the controllers 123, 143, or 106 is configured to provide synchronized signals to the modulated energy source and the energy-directing surfaces 122, 142, or 101 to operate the energy sources and the energy-directing surfaces to selectively direct modulated energy along different energy propagation paths.

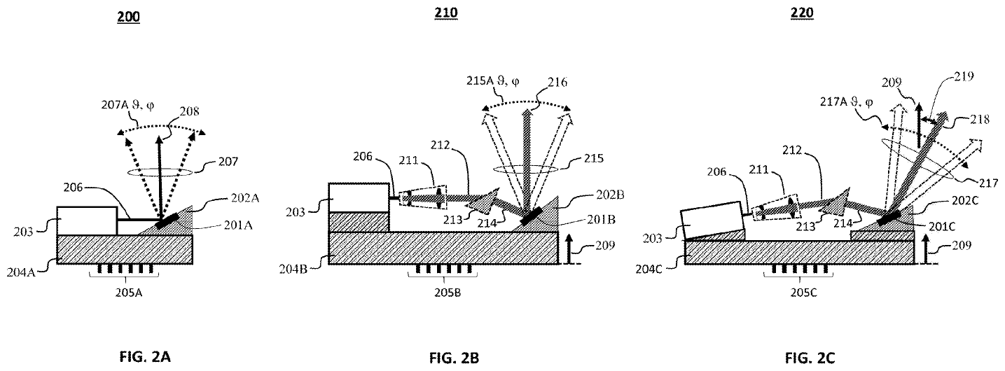

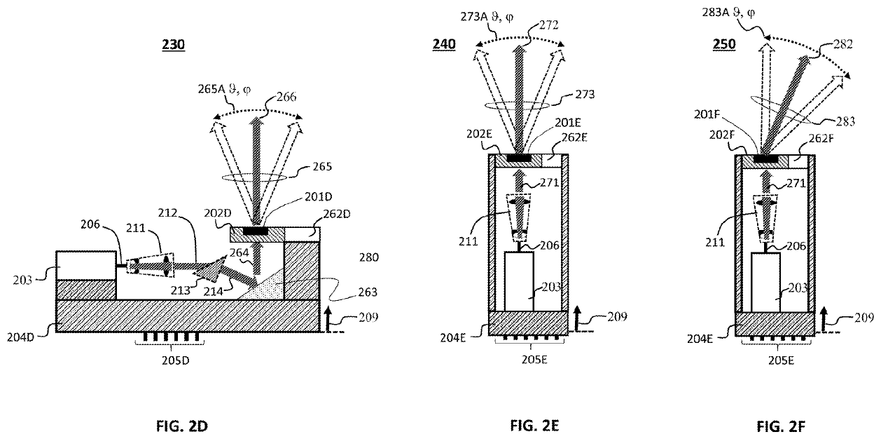

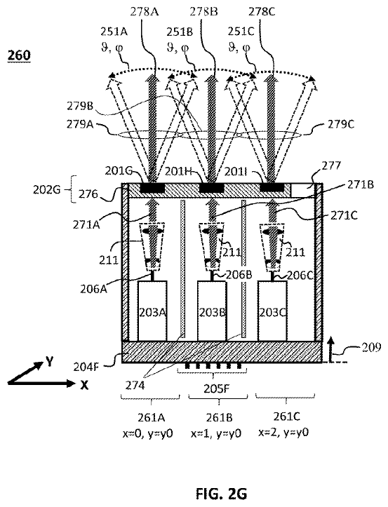

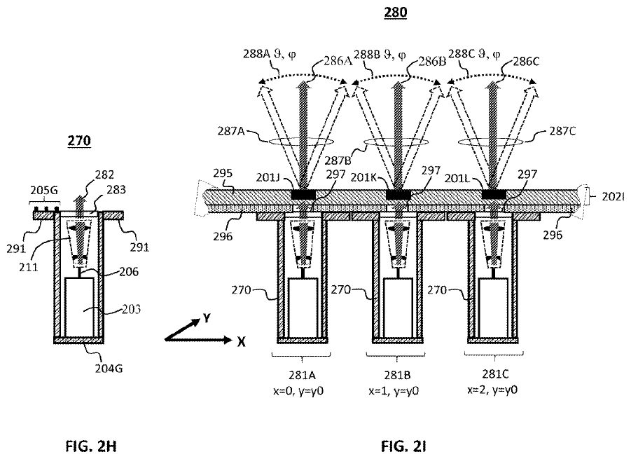

FIG. 2A is an orthogonal side view of an energy-directing module 200 comprised of an energy source 203 directing a beam of energy 206 at an energy-directing device 202A with a configurable energy-directing surface 201A which deflects the beam in two axes (ϑ, φ) 207, although deflection in only one axis is shown for illustrative purposes. The energy source 203 may produce energy which is collimated, modulated, or both collimated and modulated. The energy-directing surface 201A may be a configurable metasurface, a tilting energy reflector, or any other device or combination of devices which can tilt the incident beam 206 in two axes. The deflected beam may be any one of a multitude of energy propagation paths 207 in two orthogonal axes ϑ, φ, the two-dimensional angular deflection range 207A depending on the configuration of the energy-directing device 201A and the tilt deflection resolution of the energy-directing device 202A. The possible deflected beam energy propagation paths 207 are grouped around an energy propagation axis 208, which may be an axis of symmetry for with respect to an angular range of the energy propagation paths 207. The energy-directing device 202A and the energy source 203 are both mounted on the mechanical base 204A, which may contain processors, electronic drive circuits, electronic feedback circuits, energy source modulation components, electrical leads 205A, and any other components for implementing various aspects of the operations of the energy-directing device and the energy source.

In an embodiment, additional energy modifying components may be added to the energy-directing module 200 in order to achieve different functions. For example, for visible electromagnetic energy, if the energy source 203 is an edge-emitting laser, the energy beam profile may be elongated in one dimension but not the other. A prism may be used to expand the beam in one dimension to generate a more symmetrical beam shape. Also, many sources such as an edge-emitting laser or a vertical cavity surface emitting laser (VCSEL) may generate a divergent beam, which can be corrected with the addition of one or more lenses. For the projection of ultrasound, it is possible to mount similar components with varying values of acoustic impedance. The energy sources such as an edge-emitting laser or a VCSEL may be directly modulated or have eternal modulators which can quickly turn on the energy source a specified energy, or substantially turn off the energy source. In another embodiment, the energy modulation source may be a shutter that is part of the energy source 203, disposed between the energy source 203 and the energy-directing surface 201A, or in the outgoing paths 207 from the energy-directing surface 201A. This shutter, not shown in FIG. 2A, may be comprised of a mechanical or electrooptical shutter such as an LC panel.

FIG. 2B is an orthogonal side view of an energy-directing module 210 comprised of an energy source 203 directing energy 206 through energy beam-modifying components 211 and 213 and to a beam-deflection device 201B with a configurable energy-directing surface 202B which deflects the incident beam 214 in two axes ϑ, φ 215A. The energy source 203 may produce energy which is collimated, modulated, or both collimated and modulated. The incoming energy 206 from source 203 has its cross-sectional area expanded by beam expander 211, becoming energy beam 212, which undergoes refractions at the two surfaces of prism 213, which results in one dimension of the beam 212 becoming enlarged, and transformed into energy beam 214. Energy beam 214 is deflected by the energy-directing device 202B in any one of a multitude of energy propagation paths 215 in two orthogonal directions ϑ, φ, the two-dimensional angular deflection range 215A depending on the two-axis tilt configured on the energy-directing surface 201B of energy-directing device 202B. The possible deflected energy propagation paths 215 are grouped around an energy propagation axis 216, which describes the direction of energy propagation, and may be an axis of symmetry for an angular range of the energy propagation paths 215 leaving energy-directing module 210. Note that in this configuration, the energy propagation axis 216 is aligned with the normal 209 to the base of the mounting base 204B, which may coincide with the mounting surface of an energy-directing system. The mechanical package for the energy-directing device 202B and the energy source 203 are both mounted on the mechanical base 204B, which may contain processors, electronic drive circuits, electronic feedback circuits, energy source modulation components, electrical leads 205B, and any other components for implementing various aspects of the operations of the energy-directing device 202B and the energy source 203. The configuration illustrated in FIG. 2B is an example implementation, and is not intended to limit the endless configurations of energy forming components that may be used to enlarge, focus, reflect, refract, diffract, redirect, diverge, minify, modulate, or otherwise process the energy to make it more suitable to be deflected by the energy-directing device 202B, and achieve a desired energy profile, which includes remaining collimated for as long as possible, being slightly focused, or being slightly defocused. It is also possible to add such components to the propagation path group 215, so they are traversed by the outbound energy after it is deflected by energy-directing device 202B, rather than before.

In some energy-directing configurations, at some locations on the corresponding energy surface, it may be advantageous to project energy in a general direction which is not orthogonal to that energy surface. FIG. 2C is an orthogonal side view of a module 220 comprised of an energy source 203 directing energy 206 through energy-modifying components 211 and 213 and to an energy-directing device 202C with configurable energy-directing surface 201C, which can deflect the incident beam 214 in two axes ϑ, φ 217A, able to generate any one of a plurality of energy propagation paths 217 that are arranged about an energy propagation axis 218 which is not orthogonal to the module base 204C. Energy propagation axis 218, which is an axis of symmetry with respect to a two-dimensional angular range 217A of energy propagation paths 217 leaving energy-directing module 220, is tilted at a non-zero deflection angle 219 relative to the normal 209 to the base of the mechanical package 204C, which may be the surface of the energy-directing system to which 220 may be mounted. In this embodiment, the mechanical package for the energy-directing device 202C and the energy source 203 are both mounted on the mechanical base 204C, which may contain processors, electronic drive circuits, electronic feedback circuits, modulation electronics for the energy source 203, electrical leads 205C, and any other components for implementing various aspects of the operations of the energy-directing device 202C and the energy source 203. The configuration illustrated in FIG. 2C is an example implementation, and is not intended to limit the endless configurations of energy forming components that may be used to enlarge, focus, reflect, refract, diffract, redirect, diverge, minify, modulate, or otherwise process the energy profile to make it more suitable to be projected into a propagation path. It is also possible to add such components after the energy has been deflected to propagation paths 217.

While FIGS. 2A, 2B, and 2C show energy-directing modules which have reflective energy-directing surfaces 201A, 201B, and 201C, respectively, transmissive configurable energy-directing surfaces may also be used in the implementation of many embodiments of the present disclosure. An example is a transmissive energy-directing metasurface comprised of transparent materials such as transparent dielectrics, silicon dioxide, glass, transparent conducting oxides such as indium tin oxide (ITO), and liquid crystal materials. FIG. 2D is an orthogonal side view of an energy-directing module 230 comprised of an energy source 203 directing energy 206 through optional energy beam-modifying components 211 and 213 and to an optional reflector 263, which changes the direction of the beam 214 upward to beam 264, directing it to the transmissive configurable energy-directing surface 201D of an energy-directing device 202D, which can deflect the incident beam 264 in two orthogonal axes ϑ, φ 265A, able to generate one of a multitude of output energy propagation paths 265 arranged in an angular range 265A in two coordinates and centered about an energy-propagation axis 266. The number of possible energy propagation paths may depend on the number of resolvable energy-directing directions in each axis ϑ, φ configurable on transmissive energy-directing surface 201D. The mechanical package 262D for the transmissive energy-directing device 202D and the energy source 203 are both mounted on the mechanical base 204D, which may contain processors, electronic drive circuits, electronic feedback circuits, modulation electronics for the energy source 203, electrical leads 205D, and any other components for implementing various aspects of the operations of the energy-directing device 202D and the energy source 203. The configuration illustrated in FIG. 2D is an example implementation, and is not intended to limit the virtually endless configurations of energy forming components that may be used to enlarge, focus, reflect, refract, diffract, redirect, diverge, minify, modulate, or otherwise process the energy to make it more suitable to be collimated or focused. It is also possible to add such components to propagation paths 265, after the energy beam has been deflected by energy-directing device 202D.

FIG. 2E is an orthogonal side view of an energy-directing module 240 comprised of the energy source 203 directing energy 206 through energy modifying component 211 (e.g. a beam expander), producing energy 271 with a larger diameter, which is incident on the transmissive configurable energy-directing surface 201E of an energy-directing device 202E, which can deflect the incident beam 271 in two orthogonal axes ϑ, φ 273A, able to generate any one of a multitude of energy propagation paths 273 in an angular range 273A centered substantially about an energy propagation axis 272. This device is similar to the device 230 shown in FIG. 2D, with a different arrangement of components, enclosed by mechanical base and encasement 204E and connector 205E. The mechanical package 262E for the energy-directing device 202E is mounted to mechanical encasement 204E. The configuration illustrated in FIG. 2E is an example implementation, and is not intended to limit the virtually endless configurations of energy forming components that may be used to enlarge, focus, reflect, refract, diffract, redirect, diverge, minify, modulate, or otherwise process energy to make it more suitable to be collimated or focused. It is also possible to add such components to propagation paths 273, after the energy has been deflected by energy-directing device 202F. In FIG. 2E, energy source 203 may be modulated. In another embodiment, the energy source 203 may be continuous, and the modulation source may be a shutter that is part of the energy source 203, disposed between the energy source 203 and the energy-directing surface 202E, or in the outgoing paths 273 from the energy-directing surface 201E. This shutter, not shown in FIG. 2E, may be comprised of a mechanical or electrooptical shutter such as an LC panel.

FIG. 2F is an orthogonal side view of an energy-directing module 250 which is similar to the energy-directing module 240 shown in FIG. 2E, differing because it contains a non-zero deflection angle for the energy propagation axis 282 which is tilted relative to the normal 209 to the mechanical base 205E of the module. The reconfigurable transmissive energy-directing surface 201F within energy-directing device 202F has been configured to deflect the incident energy beam 271 in two orthogonal axes ϑ, φ 283A, able to generate any one of a multitude of energy propagation paths 283 about axis 282. This is an example of the transmissive energy-directing surface 201F being used to generate a deflection angle. In one embodiment, this transmissive energy-directing surface 201F may be a metasurface with reconfigurable nanostructures. The mechanical package 204E encloses the energy source 203 and offers an attachment point for the mechanical mount 262F of the energy-directing device 202F and presents connector 205E for electrical connectivity.

FIG. 2G is an orthogonal side view of an energy-directing module 260 containing an energy-directing layer 202G comprised of three transmissive reconfigurable energy-directing sites defined in a common substrate, each associated with a separate 4D spatial coordinate, and each steering energy into multiple possible directions ϑ, φ. The three transmissive reconfigurable energy-directing sites 201G, 201H, and 201I, are defined in a common substrate 276, held by mechanical support 277, and controlled by one or more controllers which operate the configuration of each energy-directing site. Energy sources 203A, 203B, and 203C independently direct energy 206A, 206B, and 206C, respectively, at beam-expanders 211, creating larger-diameter energy beams 271A, 271B, and 271C, respectively, which are deflected by reconfigurable and transmissive energy-directing sites 201G, 201H, and 201I, respectively, each generating one of a multitude of propagation path groups 279A, 279B, and 279C, respectively, centered around energy propagation axes 278A, 278B, and 278C, respectively, distributed about angular ranges with coordinates ϑ, φ 251A, 251B, and 251C, respectively, located at spatial coordinates (x=0, y=y0) 261A, (x=1, y=y0) 261B, and (x=2, y=y0) 261C, respectively, where y0 is a constant. All the components are placed in a mechanical housing 204F with electrical connector 205F, which gives electrical access to the controller (not shown) of each energy source 203A, 203B, and 203C, as well as the one or more controllers of the energy-directing sites (not shown) within common substrate 276.

In an embodiment, the energy sources 203A, 203B, and 203C are aligned with respect to the common energy-directing site substrate 276 such that each energy source substantially provides energy to only one of the transmissive reconfigurable sites 201G, 201H, and 201I. To reduce or eliminate stray energy from an energy source from reaching a neighboring energy-directing site, energy 271A, 271B, and 271C may be substantially isolated from the respective neighbors with an energy-inhibiting structure 274, which, in an embodiment, may include a mechanical baffle structure which blocks energy.

The transmissive reconfigurable energy-directing sites 201G, 201H, and 201I of the energy-directing module 260 are located at coordinates 261A, 261B, and 261C, each containing a single spatial coordinate (x,y)=(0, y0), (1, y0), and (2, y0), respectively, and each associated with a plurality of energy propagation paths which may be projected in a two-dimensional angular range (ϑ, φ) 251A, 251B, and 251C, respectively. Together, these two position coordinates (x, y) and the two angular coordinates (ϑ, φ) correspond to a multitude of 4D coordinates (x=0, y0, ϑ, φ), (x=1, y0, ϑ, φ), and (x=2, y0, ϑ, φ). Ultimately, the number of achievable positions of each projected energy beam in ϑ, φ axes depends on the detailed construction of the energy-directing sites 201G, 201H, and 201I, determining the field-of-view and number of resolvable output angles achievable in each axis. The configuration illustrated in FIG. 2G is an example implementation, and is not intended to limit the endless configurations of energy forming components that may be added to the energy propagation path either prior to being deflected by the energy-directing sites 201G, 201H, and 201I, or after, used to enlarge, focus, reflect, refract, diffract, redirect, diverge, minify, modulate, control polarization, or otherwise process the energy to make it more suitable for a particular energy-directing application.

FIG. 2G shows an energy-directing module comprising three independent energy sources and associated energy propagation paths delivering independently controlled energy beams to three independent reconfigurable energy-directing sites within a common substrate. It is possible to construct a modular system around a substrate with many independently reconfigurable energy-directing sites, using modular energy sources. FIG. 2H is an orthogonal side view of a modular energy source 270, comprised of an energy source 203 producing energy 206 which may be expanded by an energy modifying component or set of components 211 (e.g., a beam expander), producing output energy 282. The energy 282 may travel through a protective transmissive window 283 of the mechanical encasement 204G, wherein the mechanical encasement is comprised of an electrical connector 205G which provides control of the energy source, possibly including DC bias and modulation control, and possibly a pair of mounting flanges 291 or some similar mechanical construct which allows the module to be secured to a surface. The configuration illustrated in 270 is an example implementation, and is not intended to limit the endless configurations of energy forming components that may be used to enlarge, focus, reflect, refract, diffract, redirect, diverge, minify, modulate, or otherwise process the energy to make it more suitable to be projected.

FIG. 2I shows an orthogonal view of an energy-directing system with an energy-directing layer 202I comprised of multiple independently controlled energy-directing sites 201J, 201K, and 201L, contained in a single substrate 295, each deflecting energy from an energy-source module 270. Note that while FIG. 2I shows a particular energy source module 270, there are endless of configurations for energy source modules which could be used in place of 270. In at least one embodiment, an energy source module producing a substantially collimated beam of energy can be used. In another embodiment, an energy source module producing energy which is substantially collimated but contains some convergence (focus) or divergence (defocus) may be used. Each energy source module 270 is shown attached to a common backplane layer 296, which may function as any of: a mechanical support structure for mounting energy source modules 270, a mechanical support structure for the energy-directing substrate 295, an electrical backplane which offers controls and connectivity for each energy source 270, and an electrical backplane which offers controls and connectivity for each energy-directing site 201J, 201K, and 201L. This backplane layer 296 contains apertures 297 aligned with each energy-directing site 201J, 201K, and 201L, each providing a clear path for the beam of an energy source module 270 to reach the corresponding energy-directing site. Energy-directing system 280 is shown with three coordinates 281A, 281B, and 281C, each associated with a single spatial coordinate (x, y)=(0, y0), (1, y0), and (2, y0), respectively, with y0 a constant in this case, wherein at each of these spatial coordinates one of a group of energy propagation paths 287A, 287B, and 287C, respectively, are projected outward from the substrate surface 295, centered around an energy propagation axis 286A, 286B, and 286C, respectively, where these possible propagation paths populate a two-dimensional angular range (ϑ, φ) 288A, 288B, and 288C, respectively. Together, these coordinates correspond to the multitude of 4D coordinates (x=0, y0, ϑ, φ), (x=1, y0, ϑ, φ), and (x=2, y0, ϑ, φ). While FIG. 2I shows an energy-directing system with only three spatial coordinates associated with energy sources 270 and energy-directing surface sites 201J, 201K, and 201L, it is possible to have any number of spatial coordinates corresponding to independently-controlled energy-deflecting sites, where one or more energy-directing surface sites may be defined within a substrate, and the entire system may contain one or more such substrates. The configuration illustrated in FIG. 2I is an example implementation, and is not intended to limit the endless configurations of energy forming components that may be added to the energy propagation path either prior to being deflected by the energy-directing sites 201J, 201K, and 201L, or after, used to enlarge, focus, reflect, refract, diffract, redirect, diverge, minify, modulate, control polarization, or otherwise process the energy to make it more suitable for a particular energy-directing application.

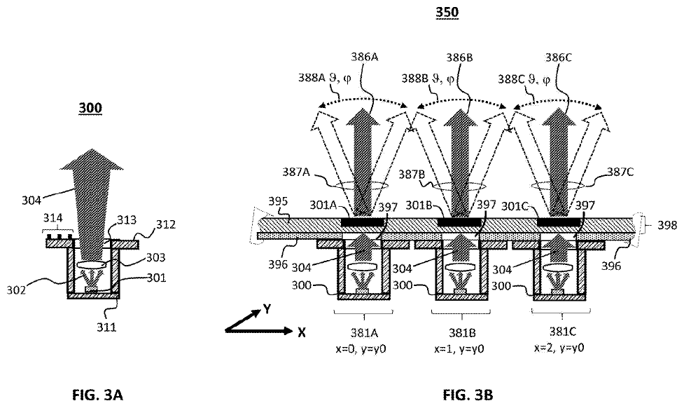

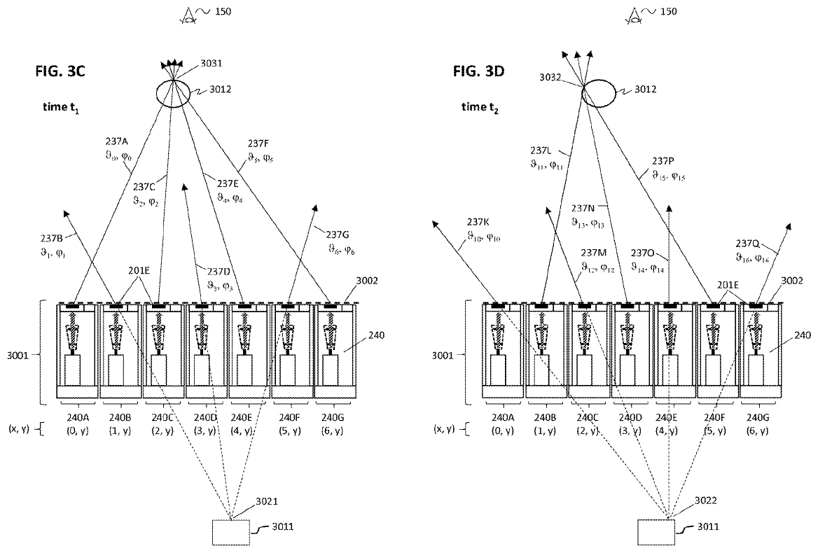

A highly collimated energy source may be used for energy propagation through a long distance without energy density dissipation. In an embodiment, an energy-directing system may be configured using energy sources that approximate perfectly collimated energy sources but have slightly focused or defocused energy. In this case, the energy-directing device may be configured to perform a correction to produce a more collimated beam of energy. FIG. 3A is an orthogonal side view of a modular energy source 300 comprised of a single point-like energy source 301, and a single focusing element 303, producing an energy beam 304 with a significant divergence associated with it. This is an alternative of the modular energy source 270 shown in FIG. 2H, which may contain an energy source with a more collimated beam 206 and more correction elements such as beam expander 211. The energy rays 302 from the point-like energy source 301 are focused to result in a slight divergence 304. The point-like energy source 301 and the focusing element 303 are enclosed in a mechanical encasement 311, which may have mounting flanges 312, a window 313 transparent to the energy beam, and a connector 314 to offer bias and modulation signals to the point-like energy source 301. In one embodiment, for visible electromagnetic energy, the point source 301 may be a single illumination source such as a LED, emitting a single wavelength, a narrow band of wavelengths, or a broad spectrum of wavelengths, and focusing element 303 may be a single lens, or a multi-element lens. A beam focused from a finite-sized source will have a divergence with a calculable lower bound that improves with a smaller source size, and a wider lens aperture. However, some minimum divergence is guaranteed for a refractive lens system.

FIG. 3B shows an orthogonal view of an energy-directing system with an energy-directing surface device 398 comprised of multiple independently-controlled reconfigurable energy-directing surface sites 301A, 301B, and 301C, contained in a single substrate 395, each energy-directing site configured to deflect energy from an energy-source module 300 shown in FIG. 3A, and correct for the energy divergence of the energy module 300 to produce output energy which is significantly more collimated. Note that while FIG. 3B shows a particular energy-source module 300 in use, there are endless of configurations for energy source modules which could be used in place of 300. In at least one embodiment, an energy source module producing a substantially collimated energy can be used. In another embodiment, an energy source module producing energy which is substantially collimated but diverging, like 304 shown in FIG. 3A, may be used. In another embodiment, the energy source module is substantially uncollimated. Each energy source module 300 is shown attached to a common backplane layer 396, which may function as any of: a mechanical support structure for mounting energy source modules 300, a mechanical support structure for the energy-directing surface substrate 395, an electrical backplane which offers controls and connectivity for each energy sources 300, and an electrical backplane which offers controls and connectivity for each energy-directing surface sites 301A, 301B, and 301C. This backplane layer 396 contains apertures 397 aligned with each energy-directing site 301A, 301B, and 301C, each providing a clear energy propagation path for the beam of an energy source module 300 to reach the energy-directing substrate. Energy-directing system 350 is shown with three coordinates 381A, 381B, and 381C, each associated with a single spatial coordinate (x, y)=(0, y0), (1, y0), and (2, y0), respectively, where at each of these spatial coordinates energy of a group of possible energy propagation paths 387A, 387B, and 387C, respectively, is projected outward from the surface of substrate 395, centered around an energy propagation axis 386A, 386B, and 386C, respectively, where possible propagation paths populate a two-dimensional angular range (ϑ, φ) 388A, 388B, and 388C, respectively. Together, these coordinates correspond to the multitude of 4D coordinates (x=0, y0, ϑ, φ), (x=1, y0, ϑ, φ), and (x=2, y0, ϑ, φ). Note that the beams approaching the energy-directing regions 301A, 301B, and 301C are divergent, as shown in 304 in FIG. 3A. However, the energy which leave the energy-directing regions 301A, 301B, and 301C and directed into energy propagation path groups 387A, 387B, and 387C, respectively, are shown leaving the energy-directing sites as collimated energy. This means that the energy-directing sites 301A, 301B, and 301B have been configured to perform a slight focusing of the input energy 304 shown in FIG. 3A, in addition to deflecting the beam into one of many possible propagation paths in two angular axes. While FIG. 3B shows an energy-directing system with only three spatial coordinates associated with energy sources 300 and energy-directing sites 301A, 301B, and 301C, it is possible to have any number of spatial coordinates, each corresponding to an independently-controlled energy-directing site, where one or more energy-directing sites may be defined within a substrate, and the entire system may contain one or more such substrates. The configuration illustrated in 350 is an example implementation, and is not intended to limit the endless configurations of energy forming components that may be added to the energy propagation path either prior to being deflected by the energy-directing sites 301A, 301B, and 301C, or after being deflected, used to enlarge, focus, reflect, refract, diffract, redirect, diverge, minify, modulate, control polarization, or otherwise process the energy to make it more suitable for a particular energy-directing application.

It is possible to project one or more holographic objects from an array of energy-directing surfaces, whether each energy-directing surface is part of a separate module with its own energy source, the energy-directing surfaces are defined in sites that share a common substrate, or if the energy-directing surface is transmissive or reflective. FIG. 3C is an orthogonal view of an electromagnetic energy directing system 3001 comprised of an array of the energy-directing modules 240 at a first instance of time, t₁. The energy-directing modules 240 are shown in FIG. 2E FIG. 3D is the energy directing system 3001 shown in FIG. 3C at a second instance in time, t₂. The first and second instances in time, t₁ and t₂ may both occur within the same refresh period of holographic content being provided by the energy-directing system 3001, where the refresh period may be the inverse of the frame rate of holographic video. The energy directing system 3001 projects energy along energy propagation paths 237A-G for each energy-directing module 240A-G, and the energy propagation paths converge at points on either a holographic object 3011, projected behind the energy-directing system surface 3002 relative to an observer 150, or on a holographic object 3012, in front of the energy-directing system surface 3002 relative to an observer 150. The energy is shown as thin chief rays in FIGS. 3C and 3D, but they have a beam width cross section area that is a substantial fraction of the area of each energy-directing module 240 in the plane of the energy-directing system surface 3002. The energy-directing module is comprised of energy modules 240A-G with spatial coordinates (x, y)=(0-6, y) each directing energy along energy propagation paths 237A-G with angular coordinates (ϑ, φ)=(ϑ₀₋₆, φ₀₋₆), respectively. Together, these two spatial coordinates and two angular coordinates form a 4D coordinate (x, y, ϑ, φ) for each energy propagation path. The energy propagation paths 237A-G converge either at first location 3021 of holographic object 3011 or first location 3031 of holographic object 3012 in FIG. 3C, and to second location 3022 of holographic object 3011 or second location 3032 of holographic object 3012 in FIG. 3D. In FIG. 3C, at the first instance of time t₁, energy along energy propagation paths 2376 at (1, y, ϑ₁, φ₁), 237D at (3, y, ϑ₃, φ₃), and 237G at (6, y, ϑ₆, φ₆) appears to diverge from point 3021 on in-screen holographic object 3011, while energy along energy propagation paths 237A at (0, y, ϑ₀, φ₀), 237C at (2, y, ϑ₂, φ₂), 237E at (4, y, ϑ₄, φ₄), and 237F at (5, y, ϑ₅, φ₅) converge at point 3031 on out-of-screen holographic object 3012. At the second instance in time t₂, energy along energy propagation paths 237K at (0, y, ϑ₁₀, φ₁₀), 237M at (2, y, ϑ₂, φ₁₂), 2370 at (4, y, ϑ₄, φ₁₄), and 237Q at (6, y, ϑ₆, φ₁₆) appear to diverge from point 3022 on in-screen holographic object 3011, while energy along energy propagation paths 237L at (01 y, ϑ₁₁, φ₁₁), 237N at (3, y, ϑ₁₃, φ₁₃), 237P at (5, y, ϑ₁₅, φ₁₅) converge at point 3032 on out-of-screen holographic object 3012. The energy-directing surface site 201E for each energy-directing module 240 may be configured to direct energy along many energy propagation paths with different angular coordinates to contribute to projecting the holographic objects 3011 and 3012. In an embodiment, these holographic objects are formed repeatedly every interval of time called a refresh period, which, in the embodiment of holographic content, is the inverse of the frame rate. Within each energy-directing module 240, the number of achievable addressable angles per refresh period for the formation of perceivable holographic objects at an acceptable brightness may depend on the speed of each energy-directing module to change angle of the energy propagation path and the brightness of the energy source. In an embodiment, the energy source may be kept on while the energy-directing module changes the angle of the energy propagation path. In another embodiment, the energy source may be turned on, held on briefly, and then turned off while the energy-directing surface dwells for a short period at each angle of a sequence of angles in two dimensions. Ideally, each energy-directing module may cover many energy-directing angles per refresh period for the formation of holographic objects 3011 and 3012. In FIG. 3C, the energy along energy propagation paths 237A, 237C, 237E, and 237F are shown to converge to the same point 3031 of the holographic object 3012 at the same moment, but such a simultaneous convergence of energy is not required for the formation of the holographic object 3012 with respect to the observer 150. The energy-directing system 3001 may be configured to refresh all or part of a scene of holographic objects within a refresh period by scanning each energy-directing site in a sequence of angles (ϑ, φ) that may follow the most efficient raster scan ordering for the energy-directing device. This means that the energy propagation path corresponding to four-dimensional coordinates (x, y, ϑ, φ) may be projected at any time and at any order within a refresh period of the light field display 3001 shown in FIGS. 3C and 3D, i.e. energy along energy propagation paths 237A, 237C, 237E, and 237F may all be directed at different times. The observer 150, through the persistence of vision, should be able to observe the holographic objects if the frame refresh rate, energy source brightness, number of angles achieved by the energy-directing device per refresh period, and density of energy propagating modules is sufficiently high to be observed by a viewer 150 against ambient light.

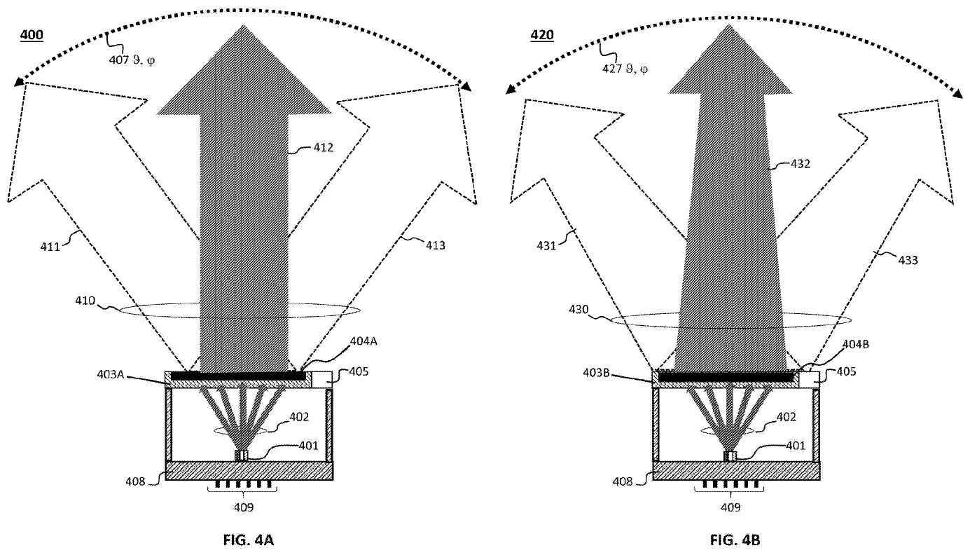

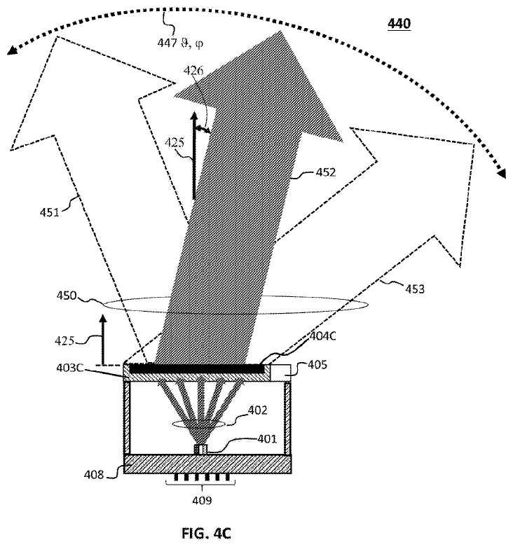

While a highly collimated energy source allows energy beam propagation through a long distance without energy density dissipation, an energy-directing system may be constructed using energy sources that are substantially divergent and energy-directing surfaces configured to perform both energy collimation and energy deflection to produce a collimated energy throughout a range of output angles in two axes. FIG. 4A is an orthogonal side view of an energy-directing module 400 which comprises a single energy source 401 with no energy focusing element (e.g. focusing element 303 in FIG. 3A) producing energy 402 with a divergent profile, and also comprising a configurable transmissive energy-directing device 403A which corrects for this divergence and produces collimated and deflected output beams. The energy source 401 may be a single point-like energy source, like a single-color energy source, or a site with multiple energy sources, such as red, green, and blue LEDs that are closely spaced on a substrate or on discrete devices. The reconfigurable transmissive energy energy-directing surface 404A within device 403A, supported by mechanical package 405, performs both energy deflection as well as energy focusing to produce a collimated output energy along energy propagation paths within an angular range in ϑ, φ 407, including possible energy propagation paths 411, 412, and 413, grouped around energy propagation axis 412. The energy-directing device 403A with energy-directing surface (or site) 404A, the energy-directing mechanical mount 405, and the energy source 401 are enclosed in a mechanical package 408, with connector 409 to route the energy source bias and modulation signals, and signals to or from the controller of the energy-directing device 403A, which may or may not be found within the mechanical package 408. The configuration illustrated in FIG. 4A is an example implementation, and is not intended to limit the endless configurations of energy forming components that may be added to the energy propagation path either prior to being deflected by the energy-directing surface 404A, or after being deflected, used to enlarge, focus, reflect, refract, diffract, redirect, diverge, minify, modulate, control polarization, or otherwise process the energy to make it more suitable for a particular energy-directing application.

The energy-directing element may be configured to produce energy which are slightly focused or diverging, depending on the application. FIG. 4B is an orthogonal side view of an energy-directing module 420 which contains a single energy source 401, and no energy focusing element (e.g. focusing element 303 in FIG. 3A), producing a plurality of energy rays 402 that are substantially divergent, and with an energy-directing element which corrects for this divergence and produces substantially collimated but slightly focused output energy. The reconfigurable transmissive energy energy-directing surface 404B within energy-directing device 403B mounted with mechanical mount 405 performs both energy deflection as well as energy focusing to produce collimated but slightly focused output energy within an angular range in ϑ, φ 427, including possible energy propagation paths 431, 432, and 433, found in a group of possible propagation paths 430 around energy propagation axis 432, which may be aligned with the average energy vector for these possible propagation paths. The configuration illustrated in FIG. 4B is an example implementation, and is not intended to limit the endless configurations of energy forming components that may be added to the energy propagation path either prior to being deflected by the energy-directing surface 404B, or after being deflected, used to enlarge, focus, reflect, refract, diffract, redirect, diverge, minify, modulate, control polarization, or otherwise process the energy to make it more suitable for a particular energy-directing application.

The energy-directing element may be configured to produce energy with a deflection angle, as previously discussed. FIG. 4C is an orthogonal side view of an energy-directing module 440 which is comprised of a single energy source 401, and no energy focusing element (e.g. focusing element 303 in FIG. 3A), yet produces energy that is collimated, along energy propagation paths grouped around an energy projection axis 452 which is tilted relative to a normal 425 to the energy-deflecting surface 404C. Energy-directing module 440 has an energy-directing device 403C which transforms the incident diverging energy rays 402 into an output collimated energy beam within an angular range in ϑ, φ 447, including possible energy propagation paths 451, 452, and 453, found in a group 450 around energy propagation axis 452. This energy propagation axis 452, which is an axis of symmetry respect to an angular range of the propagation paths, is tilted at a non-zero angle 426 relative to the normal 425 to the surface of the reconfigurable energy-directing device 403C with transmissive energy energy-directing surface 404C. The configuration illustrated in FIG. 4C is an example implementation, and is not intended to limit the endless configurations of energy forming components that may be added to the energy propagation path either prior to being deflected by the energy-directing surface 404C, or after being deflected, used to enlarge, focus, reflect, refract, diffract, redirect, diverge, minify, modulate, control polarization, or otherwise process the energy to make it more suitable for a particular energy-directing application.

FIGS. 2A, 2B, 2C, 2D, 2E, 2F, 2G, 4A, 4B, and 4C all show energy-directing modules with several possible output energy propagation paths. However, to generate a sequence of energy propagation paths quickly, the energy-directing device in these figures may be used to scan deflected energy very quickly in two dimensions, while the energy source is modulated, in order to produce varying energy in varying directions from the energy-directing module. A controller can be used to synchronize the modulation of the energy source and the operation of the energy-directing surface to generate an intentional temporal pattern of energy propagation paths.

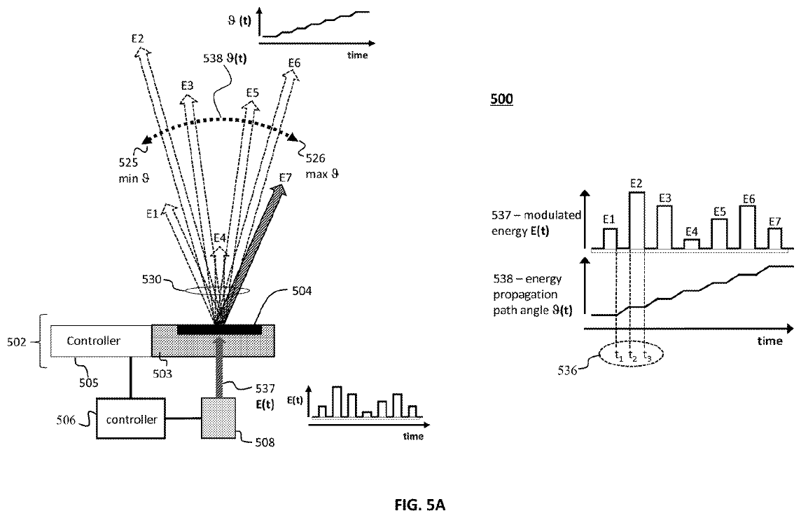

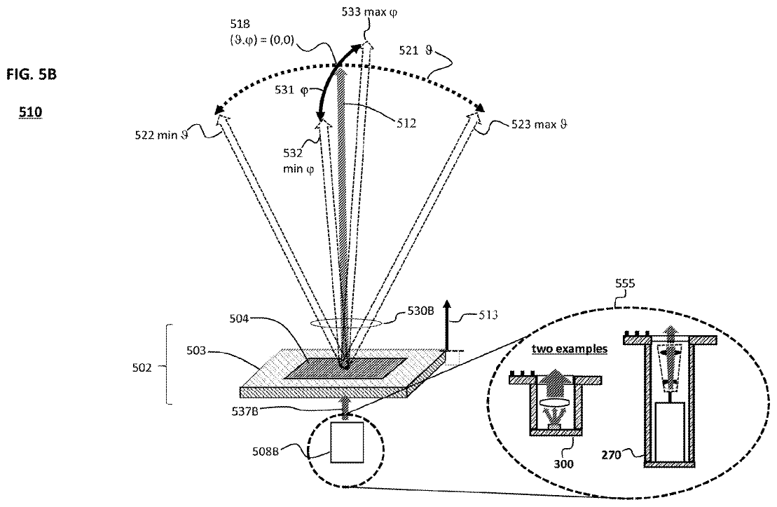

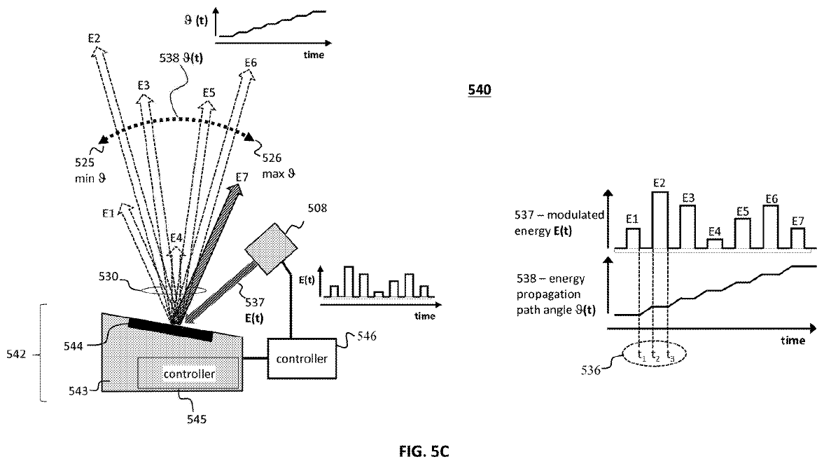

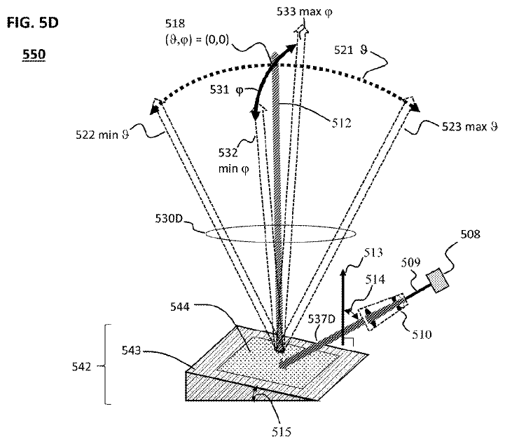

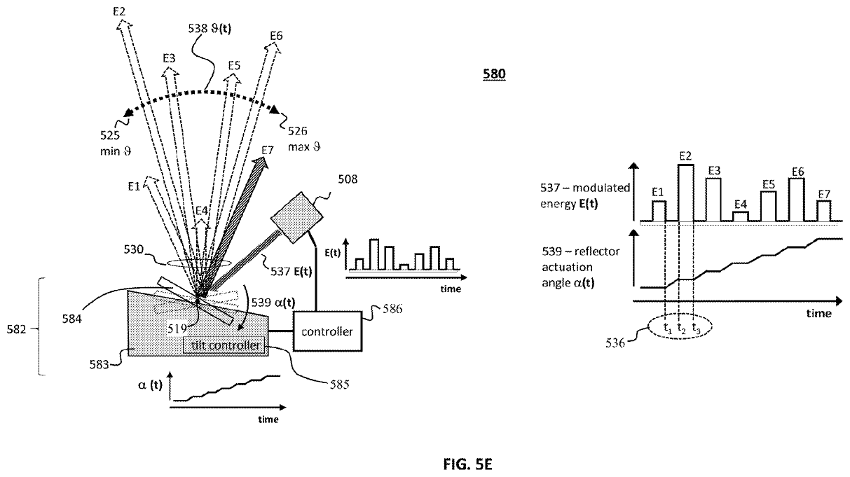

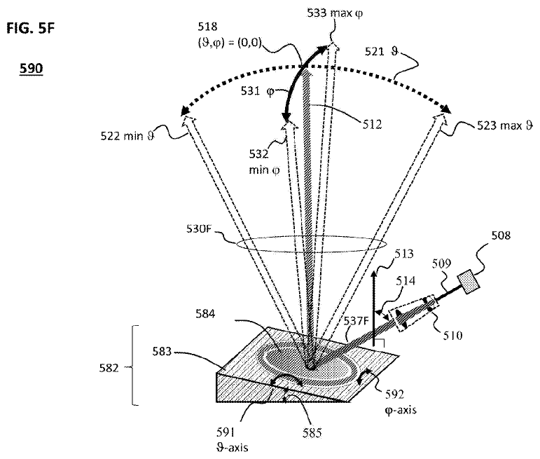

FIG. 5A is a schematic diagram of an operation of an energy-directing module 500, comprised of a modulated energy source 508 directing energy 537 at an energy-directing device 502 with a reconfigurable energy-directing transmissive surface 504. The timing diagram in FIG. 5A shows a possible synchronization between the modulation of the energy source 508 and the operation of the energy-directing surface 504 to project energy along a sequence of seven propagation paths 530 with varying energy E1-E7 across a range of output energy propagation path angles in ϑ 538 as a function of time. The energy-directing transmissive surface 504 may be an active region within a substrate 503. The energy-directing surface 504 may deflect the incident energy beam 537 in an axis φ orthogonal to ϑ, but in this simple example we only focus on one deflection axis, ϑ. The modulated energy 537 may be collimated, slightly defocused, slightly focused, or divergent. In the case of energy 537 which is not collimated or imperfectly collimated, the energy-directing surface may perform a correction to output deflected and substantially collimated output energy in the range of the minimum value of ϑ 525 and the maximum value of ϑ 526. A controller 506 is operable to generate both the modulation signal for energy source 508 to produce the modulated energy E(t) vs. time profile 537, as well as the instructions sent to the energy-deflecting device 502 to produce the energy propagation path angle ϑ(t) vs. time profile 538. In an embodiment, the instructions between the controller 506 and the energy-directing device 502 may be addressed to an energy-directing surface controller 505 to create the surface profile to achieve the energy propagation path angle ϑ 538. The plots for the modulated energy E(t) 537 and the energy propagation path angle ϑ(t) 538 are shown on the right side of FIG. 5A, with some common timing events 536. At t1, the energy source producing incident beam 537 is modulated from energy E1 to zero energy, and the energy-directing surface device 502 begins to change the angle of ϑ by reconfiguring the transmissive energy-directing surface 504. At t2, the angle ϑ 538 stops changing for a moment, and energy source 508 is modulated from zero energy to E2, which lasts from the duration from t2 to t3. In this fashion, the angle ϑ 538 is repeatedly stepped while the energy source 508 is modulated off, and the angle ϑ 538 is held steady while the energy source is modulated to the on state. The timing shown in 537 and 538 is illustrative, and not meant to limit other possibilities, which include quickly modulating the energy source so it may remain on almost all the time, changing the angle ϑ 538 smoothly, changing the angle ϑ 538 while the energy source is turned on, changing the angle ϑ 538 while the energy source is turned on and simultaneously changing energy levels, or changing the angular coordinates of the energy propagation paths in two axes ϑ and φ at the same time. This energy source modulation pattern 537 and the angle ϑ profile 538 results in the energy being directed along a sequence of energy propagation paths 530 with varying energies E1-E7. Near the minimum of the angle ϑ 525, at the earliest time in the cycle, E1 is projected to the left. Then energies E2-E7 are projected in turn, one at a time, with each successive propagation path having a slightly larger clockwise angle ϑ 538 (or equivalently, normalized light field coordinate u-value), ending at E7 projected to the right near the maximum of the angle ϑ 526. Depending on the relative speed of the energy propagation path change and the modulation frequency, energy along a large number of energy propagation paths can be projected in a fixed time period, depending on the number of resolvable angles produced by energy-directing surface device 502. And while the configuration in FIG. 5A shows just energy propagation path angle ϑ, the energy-directing surface device 502 may be configured to deflect the incident energy 537 along a second axis, orthogonal to the first axis, which means that the group of possible energy propagation paths 530 may form a cone with an apex at the reconfigurable energy-directing transmissive surface 504. The configuration illustrated in FIG. 5A is an example implementation, and is not intended to limit the endless configurations of energy forming components that may be added to the energy propagation path either prior to being deflected by the energy-directing surface 504, or after being deflected, used to enlarge, focus, reflect, refract, diffract, redirect, diverge, minify, modulate, control polarization, or otherwise process the energy to make it more suitable for a particular energy-directing application.

FIG. 5B is a perspective view of one implementation of an energy-directing module 510, which may be the same module as 500 shown in FIG. 5A, showing several possible energy propagation paths 530B generated from a reconfigurable transmissive energy-directing device 502 deflecting energy from an energy source in two orthogonal directions. The energy source module 508B may be modulated, collimated, or both. Magnified view 555 shows two examples of energy modules 508B, including energy module 270 with a collimated energy source and a beam expander, and energy module 300, with a divergent point energy source focused by a single element. However, many other configurations of energy modules are possible. For example, in the optical domain, optical elements such as prisms, lenses, diffractive elements such as gratings, mirrors, folding optics, or other optical components can be added to the beam path 537B, or to the opposite side of the beam-deflecting surface 504, in the path of energy rays 530B. The energy-directing device 502 may be the same as the energy-directing system 140 shown in FIG. 1B. The energy-directing surface 504 may be mounted within a substrate 503 of the energy-directing device 502. The energy-directing surface 504 may be configured to deflect the incident energy 5376 in ϑ to scan the deflected energy in the ϑ-axis 521 from the minimum value of ϑ 522 to the maximum value of ϑ 523. The energy-directing surface 504 may be configured to scan the deflected energy in the φ-axis 531 from the minimum value of φ 532 to the maximum value of φ 533. The energy-directing surface device 502 may deflect the incident energy 5376 in both axes (ϑ, φ) simultaneously to deflect energy along any energy propagation path with a corresponding value of (ϑ, φ). In the configuration shown in FIG. 5B, the midpoint of the energy-directing tilt range in each axis corresponds to (ϑ, φ)=(0, 0) 518, resulting in an energy propagation axis 512 which is aligned with the normal 513 to the surface of the energy-directing device 502. Other configurations are possible, where the energy propagation axis 512 may be align at a non-zero angle relative to the normal 513. Note while the tilt angles ϑ and φ define the 4D angular coordinate, but the normalized light field coordinates u and v may also be used to designate angle, respectively.

FIG. 5C is a schematic diagram showing the operation of an energy-directing module 540, comprised of a modulated energy source 508 directing energy 537 at an energy-directing device 542 with a reconfigurable energy-directing reflective surface 544. The timing diagram in FIG. 5C shows a possible synchronization between the modulation of the energy source 508 and the operation of the energy-directing surface 544 to direct energy along a sequence of seven propagation paths 530 with varying energies E1-E7 across a range of output angles in ϑ 538 as a function of time. The energy-directing reflective surface 544 may be an active region within a substrate 543. The energy-directing surface 544 may deflect the incident energy beam 537 in an axis φ orthogonal to ϑ, but in this simple example we only focus on one deflection axis, ϑ. The modulated energy 537 may be collimated, slightly defocused, slightly focused, or divergent. In the case of a beam which is not collimated or imperfectly collimated, the energy-directing surface 544 may perform a correction to output a deflected and substantially collimated output energy along propagation paths with angular direction in the range of the minimum value of ϑ 525 and the maximum value of ϑ 526. A controller 546 is operable to provide both the modulation signal for energy source 508 to produce the modulated energy E(t) vs. time profile 537, as well as signals comprising instructions sent to the energy-directing device 542 to produce the energy propagation path angle ϑ(t) vs. time profile 538. The instructions between the controller 546 and the energy-directing device 542 may be addressed to an energy-directing surface controller 545 to create the required surface profile to achieve the energy propagation path angle ϑ 538. The plots for the modulated energy E(t) 537 and the energy propagation path angle ϑ(t) 538 are shown on the right side of FIG. 5C, with some common timing events 536. At t1, the energy source producing incident energy 537 is modulated from energy E1 to zero energy, and the energy-directing device 542 begins to change the angle of ϑ by reconfiguring the transmissive energy-directing surface 544. At t2, the angle ϑ 538 stops changing for a moment, and energy source 508 is modulated from zero energy to E2, which lasts from the duration from t2 to t3. In this fashion, the angle ϑ 538 is repeatedly stepped while the energy source 508 is modulated off, and the angle ϑ 538 is held steady while the energy source is modulated to the on state. The timing shown in 537 and 538 is illustrative, and not meant to limit other possibilities, which include quickly modulating the energy source so it may remain on almost all the time, changing the energy propagation path angle smoothly, changing the energy propagation path angle while the energy source is turned on, changing the energy propagation path angle while the energy source is turned on and simultaneously changing energy levels, or changing the energy propagation path angle in two axes ϑ and φ at the same time. This energy source modulation pattern 537 and energy propagation path angle profile 538 results in the generation of the sequence of energy propagation paths 530 with varying energy E1-E7. Near the minimum of the angle ϑ 525, at the earliest time in the cycle, E1 is projected to the left. Then energies E2-E7 are projected in turn, one at a time, with each successive propagation path having a slightly larger clockwise angle ϑ 538 (or equivalently, normalized light field coordinate u-value), ending at E7 projected to the right near the maximum energy-directing surface angle, corresponding to the maximum projection angle ϑ 526. Depending on the relative speed of the changing the energy propagation path angle and the modulation frequency, a large number of energy propagation paths can be projected in a fixed period of time, depending on the number of resolvable angles produced by 542. And while the configuration in FIG. 5C shows just one propagation path angle changing, the energy-directing device 542 may be configured to deflect the energy 537 along a second axis, orthogonal to the first axis, which means that the group of possible energy propagation paths 530 may form a cone with an apex at the reconfigurable energy-directing transmissive surface 544. The configuration illustrated in FIG. 5C is an example implementation, and is not intended to limit the endless configurations of energy forming components that may be added to the energy propagation path either prior to being deflected by the energy-directing surface 544, or after being deflected, used to enlarge, focus, reflect, refract, diffract, redirect, diverge, minify, modulate, control polarization, or otherwise process the energy to make it more suitable for a particular energy-directing application. In FIG. 5C, the energy source 508 may be modulated. In another embodiment, the energy source 508 may be continuous, and the modulation source may be a shutter that is part of the energy source 508, disposed between the energy source 508 and the energy-directing surface 544, or in the outgoing energy paths 530 from the energy-directing surface 544. This shutter, not shown in FIG. 5C, may be comprised of a mechanical or electrooptical shutter such as an LC panel.

FIG. 5D is a perspective view of one implementation of an energy-directing system 550, which may be the same module as 540 shown in FIG. 5C, showing several possible energy propagation paths 530D generated from a reconfigurable reflective energy-directing device 542 deflecting energy from an energy source in two orthogonal directions. The energy source module 508 may be modulated, collimated, or both. In the implementation shown in FIG. 5D, energy 509 from source 508 may be expanded by optional energy beam expander 510, becoming expanded incident energy beam 537D. However, many other configurations of energy modules are possible, including energy modules 270 shown in FIG. 2H, or energy module 300 shown in FIG. 3A. Additionally, in the optical domain for example, optical elements such as prisms, lenses, diffractive elements such as gratings, mirrors, folding optics, polarization controllers, or other optical components can be added to the input energy path 537D, or in the optical path after being deflected from beam-deflecting surface 544, in the energy propagation paths 530D. The energy-directing device 542 may be the same as the energy-directing system 120 shown in FIG. 1A. The energy-directing surface 544 may be mounted within a substrate 543 of the energy-directing device 542. The energy-directing surface 544 may be configured to deflect the incident energy 537D in ϑ to scan the projected beam in the ϑ-axis 521 from the minimum value of ϑ 522 to the maximum value of ϑ 523. The energy-directing surface 544 may be configured to scan the deflected energy along propagation paths in the φ-axis 531 from the minimum value of φ 532 to the maximum value of φ 533. The energy-directing device 542 may deflect the incident energy 537D in both axes (ϑ, φ) simultaneously to deflect energy into any energy propagation path with a corresponding value of (ϑ, φ). In the configuration shown in FIG. 5D, the midpoint of the energy-directing tilt range in each axis corresponds to (ϑ, φ)=(0, 0) 518, resulting in an energy propagation axis 512 which is aligned with the normal 513 to the base of the substrate 543 of the energy-directing device 542. Note that the energy propagation axis 512 is made to be vertical in FIG. 5D by adjusting both the angle 515 the plane of the energy-directing surface 544 makes with the base of the energy-directing substrate 543, and the angle 514 that the incident energy 537D makes with the normal 513 to the base of the energy-directing device 542. Other configurations are possible, where the energy propagation axis 512 may be angled relative to the normal 513. Note that we are specifying the energy propagation path angles ϑ and φ, but in the embodiment of a light field display we could also use the normalized light field coordinates u and v to designate angle, respectively.

FIG. 5E is a schematic view of another operation of an energy-directing module 580, comprised of a modulated energy source 508 directing energy 537 at a tilting energy reflector 584 which tilts around an axis 519. The timing diagram in FIG. 5E shows a possible synchronization between the modulation of the energy source 508 and the operation of the energy reflector to deflect energy along a sequence of seven propagation paths 530 with varying energies E1-E7 across a range of output angles ϑ as a function of time. The modulated energy 537 may be collimated. In an embodiment, the tilting reflector 584 is a MEMS micro reflector. The energy-directing reflector device 582 is comprised of tilting energy reflector 584 which may be mounted within a substrate or a mechanical frame 583, and a tilt controller 585. The tilting reflector 504 may deflect the incident energy 537 in an axis φ orthogonal to ϑ, but in this simple example we only show one angular deflection axis ϑ. The modulated energy 537 may be collimated, slightly defocused, or slightly focused, and is deflected into output energy along energy propagation paths in the range of the minimum value of ϑ 525 and the maximum value of ϑ 526. A controller 586 is operable to provide both the modulation signal for the energy source 508 to produce the modulated energy E(t) vs. time profile 537, as well as signals comprising instructions for the energy-directing reflector device 582 with tilting energy reflector 584 to produce the reflector tilt α(t) vs. time profile 539. As a result of the reflector tilt, the output energy may be reflected into any one of many possible energy propagation paths 530, since there is a direct relationship between tilt reflector angle α and the deflected energy propagation path angle ϑ. The instructions between the controller and the energy-directing reflector device 582 with the tilting energy reflector 584 may be parsed by a tilt controller 585 to produce the appropriate tilt angle α required to achieve the energy propagation path angle ϑ. The plots for the modulated energy E(t) 537 and the mirror tilt angle α(t) 539 are shown on the right side of FIG. 5E, with some common timing events 536. At t1, the energy source 508 is modulated from energy E1 to zero energy, and the tilt angle α of the energy reflector 584 begins to change the angle ϑ. At t2, the reflector tilt angle α 539 stops changing for a moment, and energy source 508 is modulated from zero energy to E2, which lasts from the duration from t2 to t3. In this fashion, the angle α 539 is repeatedly stepped while the energy source 508 is modulated off, and the micro reflector angle α 539 is held steady while the energy source is modulated on. The timing shown in 537 and 539 is illustrative, and not meant to limit other possibilities, which include quickly modulating the energy source so it may remain on almost all the time, changing the reflector tilt angle smoothly, tilting the reflector with the energy source turned on, tilting the reflector with the energy source turned on and changing energy levels, or tilting the reflector along two orthogonal axes. This energy source modulation pattern 537 and reflector tilt angle profile 539 result in energy being directed along the sequence of energy propagation paths 530 with varying energy 537. Near the minimum of the angle ϑ 525, at the earliest time in the cycle, E1 is projected to the left. Then energies E2-E7 are projected in turn, one at a time, with each successive propagation path having a slightly larger clockwise angle ϑ 538 (or equivalently, normalized coordinate u-value), ending at E7 projected to the right near the maximum reflector tilt angle, corresponding to the maximum angle ϑ 526. Depending on the relative speed of the reflector tilt angle change and the modulation frequency, energy can be directed along a large number of energy propagation paths, depending on the resolvable number of tilt angles produced by the tilt reflector 584. And while the configuration in FIG. 5E shows just one deflection tilt axis, the energy-directing reflective device 582 may be configured to deflect the incident energy 537 along a second axis, orthogonal to the first axis, which means that the group of energy propagation paths 530 may form a cone with an apex at the surface of the tilt reflector surface 584. The configuration illustrated in 580 is an example implementation, and is not intended to limit the endless configurations of energy forming components that may be added to the energy propagation path either prior to being deflected by the energy-directing tilt reflector 584, or after being deflected, used to enlarge, focus, reflect, refract, diffract, redirect, diverge, minify, modulate, control polarization, or otherwise process the energy to make it more suitable for a particular energy-directing application.

FIG. 5F is a perspective view of one implementation of an energy-directing module 590, which may be the same module as 580 shown in FIG. 5E, showing several possible energy propagation paths generated from an energy-directing device containing a tilting energy reflector, deflecting energy from an energy source in two orthogonal directions. The energy source module 508 may be modulated, collimated, or both. In the implementation shown in FIG. 5F, energy 509 from source 508 may be expanded by optional energy beam expander 510, becoming expanded incident energy 537F. However, many other configurations of energy modules are possible, including energy modules 270 shown in FIG. 2H, or energy module 300 shown in FIG. 3A. Additionally, in the optical domain for example, optical elements such as prisms, lenses, diffractive elements such as gratings, mirrors, folding optics, or other optical components can be added to the input energy path 537F, or to the energy propagation path after being deflected from surface 584, in the energy propagation paths 530F. The tilting energy reflector 584 of the energy-directing reflector device 582 may be the same as the tilting energy reflector 160 shown in FIGS. 1C and 1D. The tilting reflector 584 may be mounted within a substrate or frame 583 of the energy-directing reflector device 582. The tilt reflector 584 tilts in the ϑ axis 591 to scan the deflected energy along propagation paths in the ϑ-axis 521 from the minimum value of ϑ 522 to the maximum value of ϑ 523. The tilt reflector 584 tilts in φ 531 to scan the deflected energy along propagation paths in the φ-axis 531 from the minimum value of φ 532 to the maximum value of φ 533. The tilt reflector may tilt in both axes (ϑ, φ) simultaneously to deflect energy 537F into any energy propagation path with a corresponding value of (ϑ, φ) within an angular range which may define the field-of-view (FOV) of the energy-directing module 590. In the configuration shown in FIG. 5F, the position of zero mirror tilt corresponds to (ϑ, φ)=(0, 0) 518, resulting in an energy propagation axis 512 which is aligned with the normal 513 to the base of the energy-directing reflector device 582. The energy propagation axis 512 is made to be vertical in FIG. 5F by adjusting both the angle 585 the surface of the tilt reflector substrate 583 makes with the base of the energy-directing reflector device 582, and the angle 514 that the energy 537F incident on the energy tilt reflector makes with the normal 513 to the base of the energy-directing reflector device 582. Other configurations are possible, where the energy propagation axis 512 may be angled relative to the normal 513. Note that here we are specifying the tilt angles ϑ and φ, but we could also use the normalized light field coordinates u and v to designate angle, respectively. In FIG. 5F, the energy source 508 may be modulated. In another embodiment, the energy source 508 may be continuous, and the modulation source may be a shutter that is part of the energy source 508, disposed between the energy source 508 and the reflective energy-directing surface 584, or in the outgoing energy paths 530F from the energy-directing surface 584. This shutter, not shown in FIG. 5F, may be comprised of a mechanical or electrooptical shutter such as an LC panel.

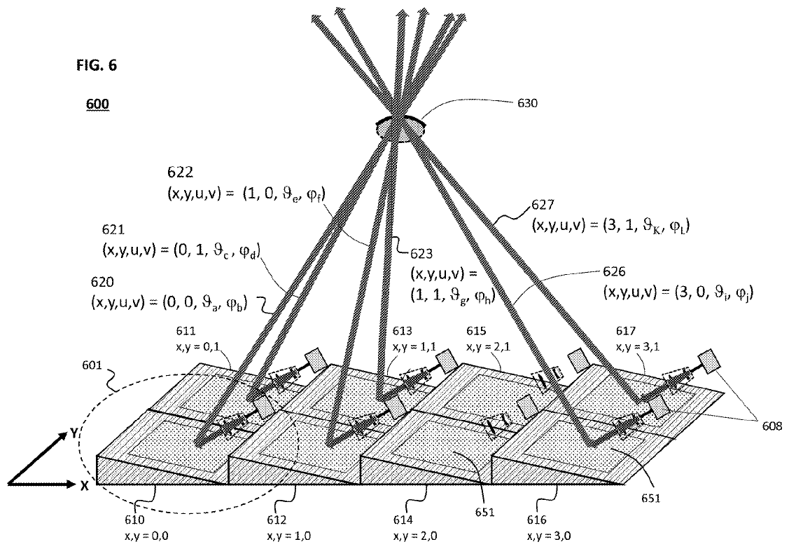

FIG. 6 is a perspective view of one implementation of an energy directing system 600 comprised of an array of eight energy-directing modules 601, each module comprising an energy-directing device redirecting the energy from an energy source into an energy propagation path which may converge with other propagation paths from other energy-directing modules to form one or more energy surfaces, including an energy surface 630. The energy-directing module 601 may be the energy-directing module with a reflective surface, including 200 shown in FIG. 2A, 210 shown in FIG. 2B, 220 shown in FIG. 2C, 540 shown in FIG. 5C, 550 shown in FIG. 5D, 580 shown in FIG. 5E, 590 shown in FIG. 5F, or some other energy-directing module which produces energy with a configurable energy level and a propagation path with a direction adjustable in angular ranges along two orthogonal angular coordinates. In the example shown in FIG. 6, the projected energy surface 630 is formed by the convergence of six propagation paths from the eight energy-directing modules. Energy-directing modules 601 are disposed in the X-axis and the Y-axis, and form integer (x, y) spatial coordinates 610-617, where x ranges from 0-3 and y ranges from 0-1. Each energy-directing module is comprised of an energy source 608 providing energy to an energy-directing surface 651 which may deflect incident energy in two axes. The energy-directing device may be comprised of a reconfigurable energy-directing surface similar to the surface 122 shown in FIG. 1A, the surface 201A shown in FIG. 2A, the surface 201B shown in FIG. 2B, the surface 201C shown in FIG. 2C, or the surface 544 shown in FIGS. 5C and 5D. The reconfigurable energy-directing device surface may instead be comprised of a tilting reflector like the reflector 101 shown in FIGS. 1C and 1D, or reflector 584 shown in FIGS. 5E and 5F. Each energy-directing module may direct an energy into a propagation path with any one of a multitude of (ϑ, φ) angular coordinates. In the example shown, the six energy propagation paths 620-623 and 626-627 all have unique values of coordinates (ϑₐ₋ᵢ, φₐ₋ᵢ). These six propagation paths may appear within a closely spaced interval of time (e.g., a refresh period), but not necessarily simultaneously, and this is discussed further below and elsewhere in the present disclosure. Energy module 610 at (x, y)=(0, 0) projects energy ray 620 with 4D coordinate (x, y, ϑ, φ)=(0, 0, ϑₐ, φ_{b}), module 611 at (x, y)=(0, 1) projects energy ray 621 with 4D coordinate (x, y, ϑ, φ)=(0, 1, ϑ_{c}, φₐ), module 612 at (x, y)=(1, 0) projects ray 622 with 4D coordinate (x, y, ϑ, φ)=(1, 0, ϑₑ, φ_{f}), module 613 at (x, y)=(1, 1) projects ray 623 with 4D coordinate (x, y, ϑ, φ)=(1, 1, ϑ_{g}, φₕ), module 616 at (x, y)=(3, 0) projects ray 626 with 4D coordinate (x, y, ϑ, φ)=(3, 0, ϑᵢ, φⱼ), and module 617 at (x, y)=(3, 1) projects ray 627 with 4D coordinate (x, y, ϑ, φ)=(1, 1, ϑₖ, φ_{L}), where the exact values of the angular (ϑ, φ) portion of these 4D coordinates are chosen so that these six rays converge at the energy surface 630. This energy surface 630 may be a tactile surface created with the projection of ultrasound energy, the surface of a holographic object with the projection of visible light, or any other energy surface. In this example, energy-directing modules 614 at (x, y)=(2, 0) and 615 at (x, y)=(2, 1) don't contribute to the energy surface 630. The configuration illustrated in 600 is an example implementation, and is not intended to limit the endless configurations of energy forming components that may be added to the beam path either prior to being deflected by the energy-directing surface 651, or after being deflected, used to enlarge, focus, reflect, refract, diffract, redirect, diverge, minify, modulate, or otherwise process the energy to make it more suitable for a particular energy-directing application.

The energy-directing system shown in FIG. 6 may produce a sequence of propagation paths for each individual energy-directing module by scanning the deflected energy in a rasterized pattern in ϑ and φ coordinates, and simultaneously modulating the energy source. The range of ϑ and φ coordinates sets the field-of-view (FOV) of the energy-directing module, which affects the FOV of the parent energy-directing system. Generally, the energy may be modulated for some number of discrete values in each axis, limited by the number of resolvable beam directions in each axis provided by the energy-directing modules 601, generating a plurality of discreet propagation paths to be achieved for a FOV, and setting the angular resolution for the projected energy. One complete raster cycle through the module's FOV determines the refresh rate for the energy-directing module, affecting the refresh rate for the energy-directing system. Using an array of energy-directing modules as shown in FIG. 6 may produce a system which forms a plurality of energy propagation paths that are stepped through every raster cycle, forming convergence points of energy along one or more energy propagation path that overlap at a given location that may be closely spaced in time (e.g., a refresh period), but not always simultaneously projected. The six propagation paths 620-623 and 626-627 shown in FIG. 600 may be projected within a closely-spaced interval of time, which may be a raster cycle, but not necessarily simultaneously, as each energy-directing surface 651 of each beam-directing module 601 may be forming a raster scan over many propagation paths in the (ϑ, φ) axes. Nonetheless, for some systems, the convergence of energy at points where one or more propagation paths of energy converge every cycle of a high-frequency refresh rate may be adequate to produce the desired effect (e.g. a persistent holographic object that may move smoothly and not be perceived to flicker). In one embodiment, for a light field display, beams of light may converge at an energy surface at slightly different times, but due to the persistence of vision, a refresh rate of 30, 60, or 120 Hz may be sufficient for a viewer to perceive a holographic object, even if it is moving. In another embodiment, for projection of a tactile surface, beams of ultrasonic energy may be converged at a location at slightly different moments in time, but with a sufficient refresh rate, the sense of touch will time average to a sensation that is indistinguishable from simultaneous convergence of all of the beams of energy. In other words, for many energy-directing systems, locations where energy beams converge over a short period of time but not simultaneously may produce the same perceived effect as if the energy converged simultaneously. The energy directing system of 600 shown in FIG. 6 and other embodiments of the present disclosure may exploit this fact to deliver a desired result.

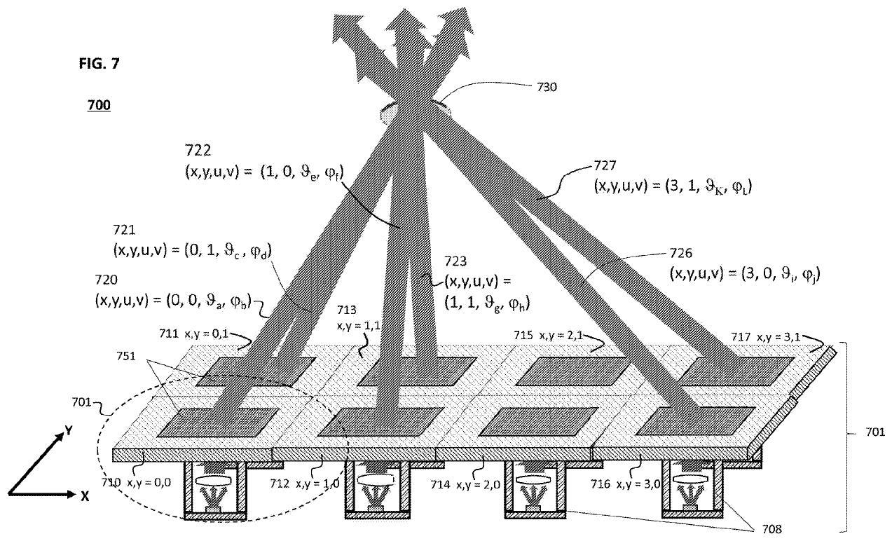

FIG. 7 is a perspective view of one implementation of an energy directing system 700 comprised of an array of eight energy-directing modules 701, each module comprising a transmissive reconfigurable energy-directing device redirecting the energy beam from a modulated energy source into an energy propagation path which may converge with other propagation paths from other energy-directing modules to form one or more energy surfaces, including energy surface 730. The energy-directing module 701 may be the energy-directing module with a transmissive surface, including 230 shown in FIG. 2D, 240 shown in FIG. 2E, 250 shown in FIG. 2F, 400 shown in FIG. 4A, 420 shown in FIG. 4B, 440 shown in FIG. 4C, 500 shown in FIG. 5A, 510 shown in FIG. 5B, or some other energy-directing module which produces an energy beam with a configurable energy level and a propagation direction adjustable in angular ranges along two orthogonal directions. In the example shown in FIG. 7, the energy surface 730 is formed by the convergence of six propagation paths from the eight energy-directing modules. Energy-directing modules 701 are disposed in the X-axis and the Y-axis, and form integer (x, y) coordinates 710-717, where x ranges from 0-3 and y ranges from 0-1. Note that each energy-directing module is associated with a spatial coordinate (x, y). Each energy-directing module is comprised of a modulated energy source 708 directing energy at a transmissive energy-directing surface 751 which may deflect an incident energy into an energy propagation path 720-723 and 726-727 with a direction defined by two angles (ϑ, φ). The energy-directing device may be comprised of a reconfigurable energy-directing surface similar to the surface 140 shown in FIG. 1B, the surface 504 shown in FIGS. 5A and 5B, or any other reconfigurable transmissive energy-directing surface. Each energy-directing module may direct energy into a propagation path with any one of a multitude of (ϑ, φ) angular coordinates. In the example shown, the six energy propagation paths 720-723 and 726-727 all have unique values of coordinates (ϑₐ₋ᵢ, φₐ₋ᵢ). These six propagation paths may appear within a closely spaced interval of time, but not necessarily simultaneously, as discussed regarding FIG. 6. Energy module 710 at (x, y)=(0, 0) projects energy ray 720 with 4D coordinate (x, y, ϑ, φ)=(0, 0, ϑₐ, φ_{b}), module 711 at (x, y)=(0, 1) projects energy ray 721 with 4D coordinate (x, y, ϑ, φ)=(0, 1, ϑ_{c}, φ_{d}), module 712 at (x, y)=(1, 0) projects ray 722 with 4D coordinate (x, y, ϑ, φ)=(1, 0, ϑₑ, φ_{f}), module 713 at (x, y)=(1, 1) projects ray 723 with 4D coordinate (x, y, ϑ, φ) (1, 1, ϑ_{g}, φₕ), module 716 at (x, y)=(3, 0) projects ray 726 with 4D coordinate (x, y, ϑ, φ)=(3, 0, ϑᵢ, φⱼ), and module 717 at (x, y)=(3, 1) projects ray 727 with 4D coordinate (x, y, ϑ, φ)=(1, 1, ϑₖ, φ_{L}), where the exact values of the angular (ϑ, φ) portion of these 4D coordinates are chosen so that these six energy propagation paths converge at the energy surface 730. This energy surface 730 may be a tactile surface created with the projection of ultrasound energy, the surface of a holographic object with the projection of visible light, or any other energy surface. In this example, energy-directing modules 714 at (x, y)=(2, 0) and 715 at (x, y)=(2, 1) don't contribute to the energy surface 730. The configuration illustrated in 700 is an example implementation, and is not intended to limit the endless configurations of energy forming components that may be added to the energy path either prior to being deflected by the energy-directing surface 751, or after being deflected, used to enlarge, focus, reflect, refract, diffract, redirect, diverge, minify, modulate, or otherwise process the energy to make it more suitable for a particular energy-directing application.

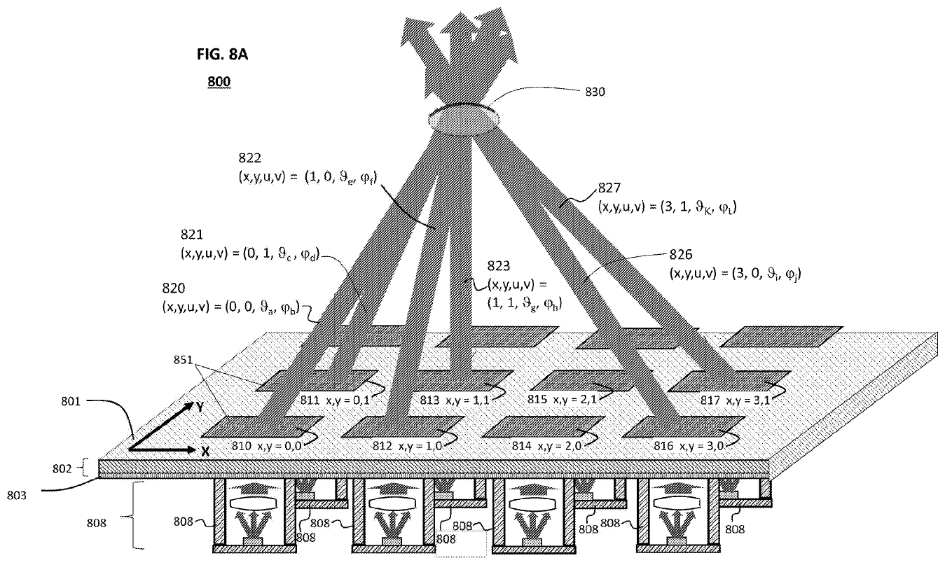

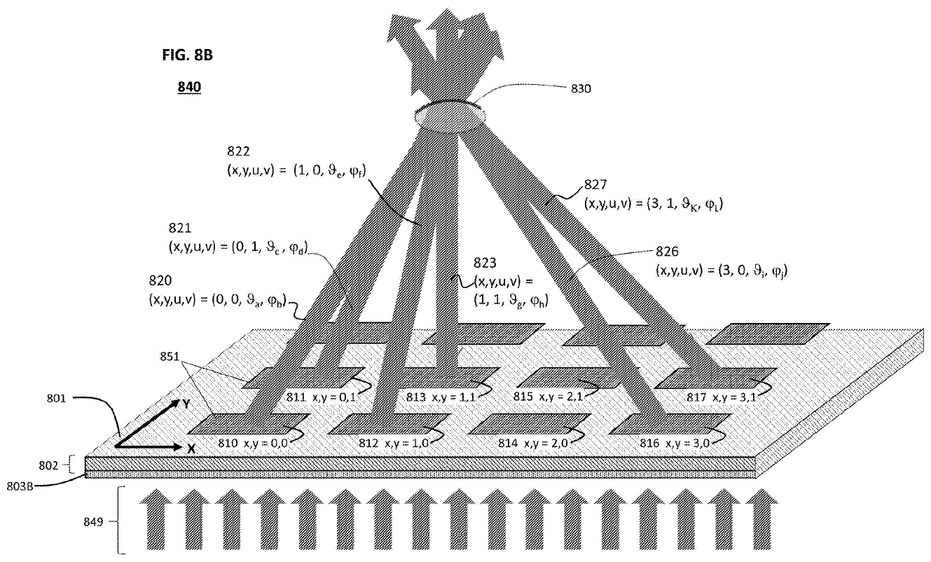

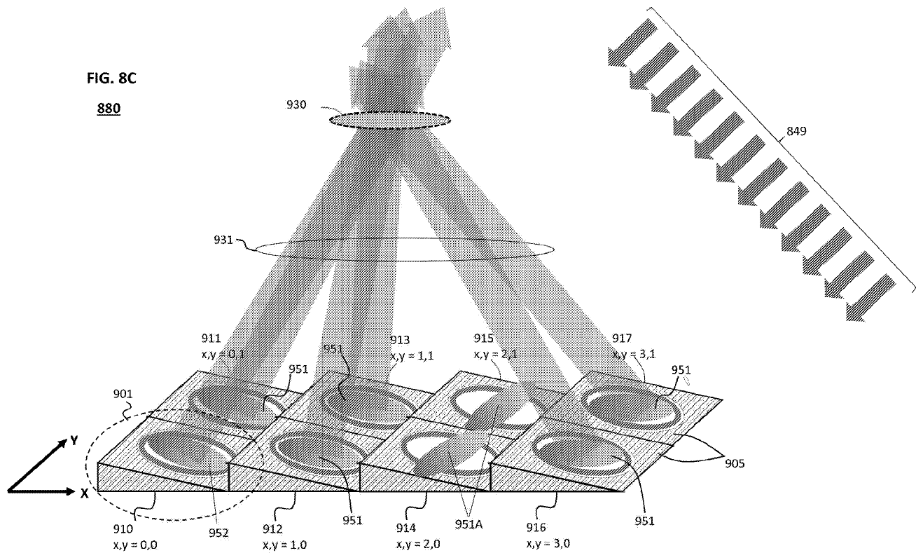

FIG. 8A is a perspective view of one implementation of an energy directing system 800 with an energy-directing layer 802 comprised of multiple independently controlled energy-directing sites 802, contained in a single substrate 801, each deflecting energy from an energy-source module 808 into two orthogonal directions ϑ, φ. FIG. 8A is one implementation of the energy directing system 280 shown in FIG. 2I, or 350 shown in FIG. 3B. While FIG. 8A shows a particular energy-source module 808, there are endless configurations for energy source modules which could be used in place of 808. In at least one embodiment, an energy source module producing substantially collimated energy can be used. In another embodiment, an energy source module producing energy which is substantially collimated but contains some convergence (focus) or divergence (defocus) may be used. In another embodiment, the energy source may be substantially converging. Each energy source module 808 is shown attached to a common backplane layer 803, which may function as any of: a mechanical support structure for mounting energy source modules 808, a mechanical support structure for the energy-directing substrate 801, an electrical backplane which offers controls and connectivity for each energy source 808, and an electrical backplane which offers controls and connectivity for each energy-directing surface site 851, including sites 810-817. This backplane layer 803 may contain apertures aligned with each energy-directing site 810-817, each providing a clear path for the beam of an energy source module 808 to reach the corresponding energy-directing substrate. These apertures are not shown in FIG. 8A, but they may be similar to the apertures 297 shown in backplane 296 in FIG. 2I.

In the example shown in FIG. 8A, the energy surface 830 is formed by the convergence of six propagation paths from the eight transmissive energy-directing surface sites 851, which are disposed in the X-axis and the Y-axis, and form integer (x, y) spatial coordinates 810-817, where x ranges from 0-3 and y ranges from 0-1. Note that each energy-directing site is associated with a spatial coordinate (x, y). Each transmissive energy-directing surface site may be comprised of a reconfigurable energy-directing surface similar to the surface 140 shown in FIG. 1B, the surface 504 shown in FIGS. 5A and 5B, or any other reconfigurable transmissive energy-directing surface. Each energy-directing module may direct an energy beam into a propagation path with any one of a multitude of (ϑ, φ) angular coordinates. In the example shown, the six energy propagation paths 820-823 and 826-827 all have unique values of (ϑ, φ) coordinates, shown with indices a-l. These six propagation paths may appear within a closely spaced interval of time, but not necessarily simultaneously, as discussed regarding FIG. 6. Energy module 810 at (x, y)=(0, 0) projects energy ray 820 with 4D coordinate (x, y, ϑ, φ)=(0, 0, ϑₐ, φ_{b}), module 811 at (x, y)=(0, 1) projects energy ray 821 with 4D coordinate (x, y, ϑ, φ)=(0, 1, ϑ_{c}, φ_{d}), module 812 at (x, y)=(1, 0) projects ray 822 with 4D coordinate (x, y, ϑ, φ)=(1, 0, ϑₑ, φ_{f}), module 813 at (x, y)=(1, 1) projects ray 823 with 4D coordinate (x, y, ϑ, φ)=(1, 1, ϑ_{g}, φₕ), module 816 at (x, y)=(3, 0) projects ray 826 with 4D coordinate (x, y, ϑ, φ)=(3, 0, ϑᵢ, φⱼ), and module 817 at (x, y)=(3, 1) projects ray 827 with 4D coordinate (x, y, ϑ, φ)=(1, 1, ϑₖ, φ_{L}), where the exact values of the angular (ϑ, φ) portion of these 4D coordinates are chosen so that these six energy propagation paths converge at the energy surface 830. This energy surface 830 may be a tactile surface created with the projection of ultrasound energy, the surface of a holographic object with the projection of visible light, or any other energy surface. In this example, energy-directing surface sites 814 at (x, y)=(2, 0) and 815 at (x, y)=(2, 1) don't contribute to the energy surface 830. The configuration illustrated in 800 is an example implementation, and is not intended to limit the endless configurations of energy forming components that may be added to the energy path either prior to being deflected by the energy-directing surface site 851, or after being deflected, used to enlarge, focus, reflect, refract, diffract, redirect, diverge, minify, modulate, or otherwise process the energy to make it more suitable for a particular energy-directing application. In FIG. 8A, the energy source modules 808 may be modulated. In another embodiment, the energy source modules 808 may produce continuous energy, and the modulation source may be a shutter that is part of the energy source module 808, disposed between the energy source module 808 and the reflective energy-directing surface sites 851, or multiple shutters in the outgoing energy paths 820-823 and 826-827 from the sites 851. These shutters, not shown in FIG. 8A, may be comprised of a mechanical or electrooptical shutter such as an LC panel.

FIG. 8B is a perspective view of another implementation of an energy directing system 840 with an energy-directing layer 802 comprised of multiple independently-controlled energy-directing sites 851 contained in a single substrate 801, each energy-directing site 851 deflecting a portion of an incident collimated energy 849 into two orthogonal directions ϑ, φ. The layer 808 of energy source modules in FIG. 8A has been replaced with incident collimated energy 849 in FIG. 8B, the collimated energy coming from one or more energy sources which are not shown. The numbering of FIG. 8A is used in FIG. 8B for similar elements. The collimated energy 849 may be produced by multiple lasers or other energy sources, from one or more point sources of light coupled to one or more collimating lenses, from one or more light sources coupled to an array of mechanical collimating structures, or from some other collimated source of energy. Each energy source module 808 is shown attached to a common backplane layer 803B, which may function as a mechanical support structure for the energy-directing substrate 801, or may provide an electrical backplane which offers controls and connectivity for each energy-directing surface site 851 including sites 810-817, or both of these. This backplane layer 803B may contain apertures aligned with each energy-directing site 810-817, each providing a clear path for a corresponding portion of the incoming energy beam 849 to reach the corresponding energy-directing substrate. These apertures are not shown in FIG. 8A, but they may be similar to the apertures 297 shown in backplane 296 in FIG. 2I.

In an alternate energy-directing configuration, a single large-area source of collimated energy may be directed at an array of energy-directing devices which individually reflect portions of the energy into desired propagation paths. FIG. 8C is a perspective view of an energy-directing system 880 comprised of an array of 2-axis energy-directing devices 901 which individually reflect portions of an incident large-area collimated energy 849 into deflected energy propagation paths 931, which converge to form an energy surface 930. In FIG. 8C, the energy-directing devices 901 are all shown with tilting energy reflectors as energy-directing surfaces 952 (e.g. similar to the reflector 101 in FIGS. 1C and 1D, and the tilting reflector 584 shown in FIGS. 5E and 5F), but they may be also be comprised of a reconfigurable energy-directing surface (e.g. similar to the surface 120 shown in FIG. 1A, the surface 201A shown in FIG. 2A, the surface 201B shown in FIG. 2B, the surface 201C shown in FIG. 2C, or the surface 544 shown in FIGS. 5C and 5D), or some other surface which deflects an incident beam of energy in two axes. Each energy-directing module may direct an energy beam into a propagation path 931 with a multitude of (ϑ, φ) angular coordinates. Eight energy-directing devices 901 located at spatial coordinates 910-917, are disposed in a 2-dimensional array along the x-axis and the y-axis, where x ranges from 0-3 and y ranges from 0-1. Note that each energy-directing device 901 is associated with a spatial coordinate (x, y). The non-tilting surface 905 that surrounds the reflecting surface 952 of each energy-directing device 901 may be energy absorbing to avoid unwanted reflections. Note that in the example of FIG. 8C, the six tilting energy reflectors 951 are all rotated so that incident energy from the incoming collimated energy 849 is reflected toward the energy surface 930. Two of the mirrors 951A are tilted away so that they reflect no significant energy toward the energy surface. As noted previously, such two-axis deflection of portions of the incident collimated beam of energy 849 can be achieved with reconfigurable energy-directing surfaces such as metasurfaces, despite being shown as tilting reflectors in FIG. 8C. The configuration illustrated in 900 is an example implementation, and is not intended to limit the endless configurations of energy forming components that may be added to the energy path after being deflected by the energy-directing surfaces 952, used to enlarge, focus, reflect, refract, diffract, redirect, diverge, minify, modulate, or otherwise process the energy to make it more suitable for a particular energy-directing application.

With a static configuration of beam deflection by each energy-directing device 901, a static 4D energy field may be projected. However, if each reflector is tilted in each axis ϑ and φ with an angle-vs-time profile that varies in time (e.g. α(t) 539 shown in FIG. 5E), dynamic 4D energy fields may be projected. It is possible to vary the deflection angle of the energy-deflecting surface 952 of each energy-directing device 901 at regular intervals to create an intentional sequence of energy propagation paths 931. The dwell time at each deflection angle may be adjusted in order to control the amount of energy projected during an interval of time. In one embodiment, the incident beam of energy 849 is modulated at a specific frequency, and the energy-directing devices are each held tilting a portion of the incident energy 849 in a fixed direction until the required energy is delivered, whereupon the reflected beam is tilted away. This means that each energy-directing device would be held in position for a different amount of time per modulation cycle. In FIG. 8B, the incoming collimated energy 849 may be modulated. In another embodiment, the incoming collimated energy 849 may be continuous energy, and the modulation source may be a shutter that is part of the backplane layer 803B, or multiple shutters in the outgoing energy paths 820-823 and 826-827 from the energy-directing surface sites 851. These shutters, not shown in FIG. 8B, may be comprised of a mechanical or electrooptical shutter such as an LC panel.

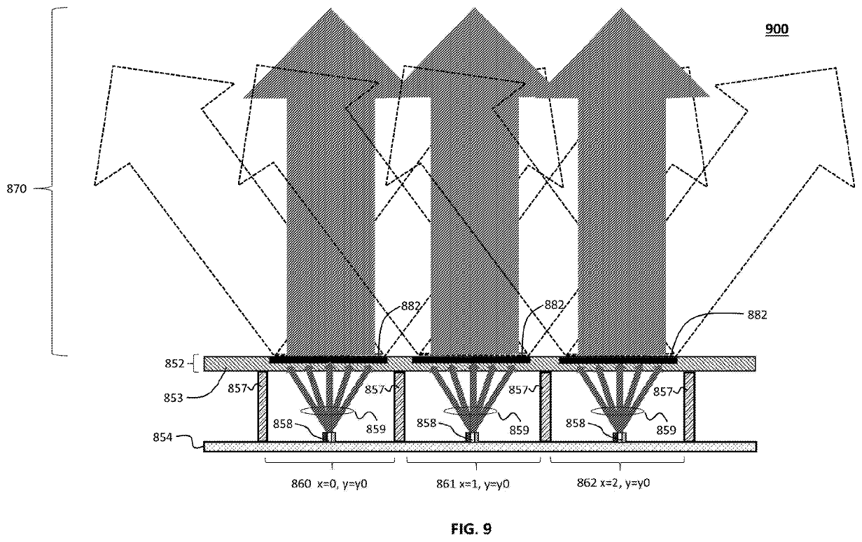

It is also possible to construct a beam-directing system with a common energy-source plane. FIG. 9 is an orthogonal view of one implementation of an energy directing system 900 with an energy-directing layer 852 comprised of multiple independently-controlled energy-directing sites 882, each site 882 comprised of an energy-deflecting surface and defined in a single substrate 853, each deflecting incident energy from one or more energy sources 858 located on a common backplane 854 into energy propagation paths 870 projected into two orthogonal angular directions ϑ, φ. The common backplane layer 854 is aligned with the energy-deflecting site substrate 853, and may function as any of: a mechanical support structure for mounting energy sources 858, a mechanical support structure for the energy-directing substrate 853, an electrical backplane which offers controls, connectivity, and mounting for each energy source 858, and an electrical backplane which offers controls and connectivity for each energy-directing site 882. The plurality of energy sources and the common backplane layer may be defined on a semiconductor substrate or a printed circuit board. The energy-directing system 900 may contain energy-inhibiting structures 857 preventing energy 859 from one energy source 858 from reaching a neighboring energy-directing surface 882 and may provide structural support from the backplane to the rest of the components. In the example of FIG. 9, the three transmissive energy-directing surface sites 882 are disposed in the X-axis, forming (x, y) spatial coordinates 860-862, where x ranges from 0-2. At each spatial coordinate (x, y), energy 859 may be deflected within some angular range in both the angular (ϑ, φ) axes, and together these spatial and angular coordinates form a 4D energy field with coordinates (x, y, ϑ, φ). The configuration illustrated in FIG. 9 is an example implementation, and is not intended to limit the endless configurations of energy forming components that may be added to each energy path either prior to being deflected by the energy-directing surface 882, or after being deflected, used to enlarge, focus, reflect, refract, diffract, redirect, diverge, minify, modulate, control polarization, or otherwise process the energy to make it more suitable for a particular energy-directing application. For example, in one embodiment there is one or more energy focusing elements (e.g. a lens for electromagnetic energy) placed in the energy propagation path of the energy 859 from each energy source 858, similar to element 303 in FIG. 3A, in order to collimate the energy from the one or more energy sources 858. In another embodiment, the energy sources 858 are each composed of a number of energy sources, such as ultrasonic transducers for the projection of ultrasonic energy, or a red, green and blue pixel group for the projection of visible light used within a light field display. Configurations with many more energy sources per energy-directing site location may also be used. In another embodiment, there may be multiple energy-directing substrates in an energy directing system, each containing more than one energy-directing surface site.

As discussed above, the energy directed from a single energy surface location may be comprised of many separate energy propagation paths (or energy rays) grouped in a solid angle around a single energy propagation axis, or center energy propagation path. This energy projection axis is a line of symmetry since it lies approximately in the midpoint of the energy propagation paths leaving a single energy surface location in both the horizontal and vertical dimensions. It is often substantially aligned with the average energy vector for the energy rays leaving a single energy surface location.

Under many circumstances, the center energy propagation path, or energy propagation axis, is normal to the surface of an energy-directing module. For example, the center energy projection axis 512 of energy-directing module 590 in FIG. 5F is aligned with the normal 513 to the base of the energy-directing device 582. Assuming that a plurality of such energy-directing modules are mounted on a first surface, the groups of energy propagation paths from each location on the energy surface are distributed in a solid angle around an axis which is normal to the first surface, independent of location on the first surface. In other words, at each location on the first surface, the energy propagation axis is aligned with the normal to the first surface. A deflection angle in the present disclosure may refer to the angle that the energy propagation axis makes with the normal to the first surface, which in an embodiment, may be a display surface. In general, the deflection angle gives the direction of energy flow from the energy surface. It describes the average deflection of a plurality of energy propagation paths at a particular location on that energy surface, relative to a normal to that surface.

For some embodiments of an energy-directing device, it may be advantageous to have the direction of energy propagation, or energy propagation axis, no longer be aligned with the normal to the display surface at some locations on the energy surface. In other words, for some locations on the energy-directing surface, there is a nonzero deflection angle. In some embodiments, the deflection angle may change with position across the energy projecting surface of the energy-directing device. This may be done to focus the projected energy rays to a more localized region. It may also allow the convergence locations for a plurality of the energy rays to be closer to the energy-directing surface, if the groups of energy propagation paths corresponding to locations near the edges of the energy-directing surface are tilted toward the center of the energy-directing surface.

To achieve various deflection angles on an energy-directing surface, it is possible to build this deflection angle into the individual energy-directing modules which are then mounted onto the display surface. Energy-directing module 210 in FIG. 2B shows a zero deflection angle, with energy propagation axis 216 parallel with the normal 209 to the mounting base of the module 204B, while energy-directing module 220 in FIG. 2C shows a non-zero deflection angle where the energy propagation axis 218 is at an angle 219 with respect to the normal 209 to the module base 204C. FIG. 5D shows that the angle of alignment 515 for the energy-directing surface 543 and the angle of approach 514 of the incident energy 537D with respect to the normal 513 to the mounting base may determine the axis of symmetry 512 for the group of energy propagation paths from an energy-directing module. In another embodiment, if a transmissive energy-directing surface is used, then the transmissive energy-directing surface may be able to induce a deflection angle, similar to the angle 426 in FIG. 4C.

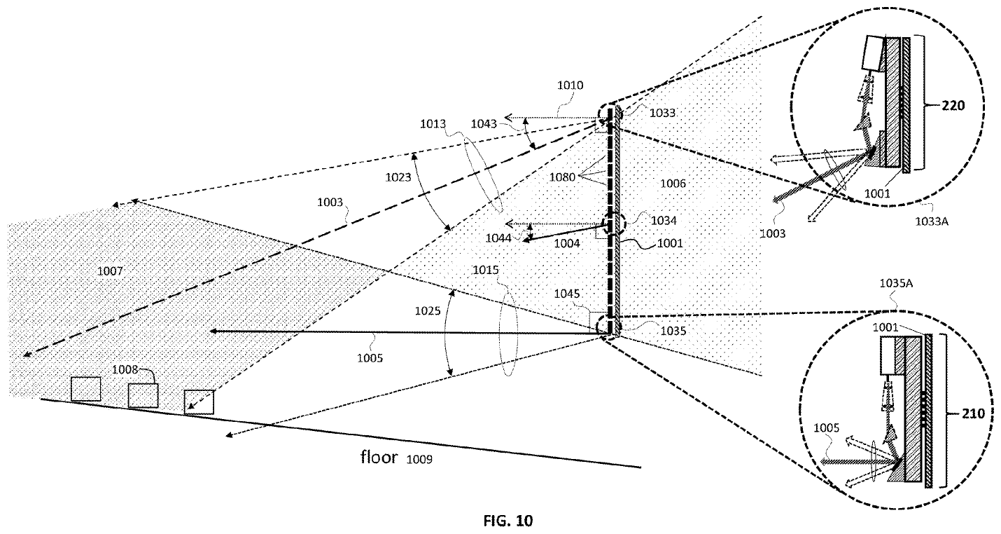

FIG. 10 illustrates an orthogonal view of a light field display system 1000 with a variable deflection angle, comprised of a plurality of energy-directing modules 1080 mounted to the surface of a light field (“LF”) display 1001, in accordance with one or more embodiments. The LF display system 1000 is projecting holographic content to an audience which resides at a location that is primarily below the midpoint height of the display, so the light projection axes for many of the projected rays are also tilted downward. Closeup 1033A shows that energy-directing modules of the type 220 shown in FIG. 2C are mounted on the top of the display near location 1033, resulting in a deflection angle which points the light projection axis 1003 downward toward the audience. The light ray group 1013 projected from the top of the display surface at location 1033 are defined by this light projection axis 1003, forming an angle 1043 with the normal 1010 to the display surface, and tilting down towards the audience seat 1008. Closeup 1035A shows that energy-directing modules of the type 210 are mounted on the bottom of the display near location 1035, with zero deflection angle for the energy propagation axis 1005. The light rays projected from the bottom of the display surface at location 1035 are defined by this energy propagation axis 1005, with a different direction than axis 1003 at the top of the display, in this case normal 1045 to the display surface. The angular spread 1023 of the projected rays 1013 about axis 1003 projected from the top of the display represents a vertical field of view 1023, while the angular spread of the group of projected rays 1015 about axis 1005 projected from the bottom of the display represents a vertical field of view 1025, where the angular spread of 1023 and 1025 may be equal. The light rays projected at positions located between the top 1033 and bottom 1035 of the display surface may have a deflection angle which varies between angle 1043 at the top of the display surface 1001, and the angle of zero (normal 1045 to the display surface) at the bottom of the display surface 1001. This variation may be a gradient, such that the light rays projected from the middle height of the display 1034 and characterized by the light projection axis 1004, are projected with a deflection angle 1044, which is a value between the deflection angle 1043 at the top of the display 1033 and the bottom deflection angle of zero (normal 1045) at the bottom of the display 1035. A possible advantage of this gradient chief ray configuration is that the viewing volume 1007 for holographic objects projected from LF display 1001 may be optimized for the anticipated seating arrangement, achieving improved performance and composite field-of-view for that set of viewers given the available angular range of projected rays of light 1023 and 1025. The configuration illustrated in 1000 is an example of one implementation and is not intended to limit the endless configurations of energy-directing modules that may be used on a flat, curved, or multi-faceted surface. Energy-directing modules that are modular and transmissive, such as 510 in FIG. 5B, or modular and reflective, such as 550 in FIG. 5D and 590 in FIG. 5F are possible to use in place of modules 1080. In another embodiment, the modules 1080 are instead implemented as one or more energy-directing systems comprised of multiple energy-directing sites located within a common substrate with energy source modules attached, like energy-directing sites 851 in 800 in FIG. 8A with energy source modules similar to energy source modules 808.

Instructions issued to an energy directing system comprised of energy-directing or beam deflection devices may be tailored to the physical characteristics of those energy-directing or beam deflection devices. For example, small incremental changes in tilt angle may be faster than large changes in tilt angle for a tilting energy reflector 160 such as a MEMS mirror shown in FIGS. 1C and 1D. The same may be true for a configurable reflective or transmissive energy-directing metasurface like those shown in FIGS. 1A and 1B, respectively. Accordingly, it may be advantageous for a controller to issue tilt commands to an energy-directing device in a sequence that matches the natural scan sequence of the physical device.

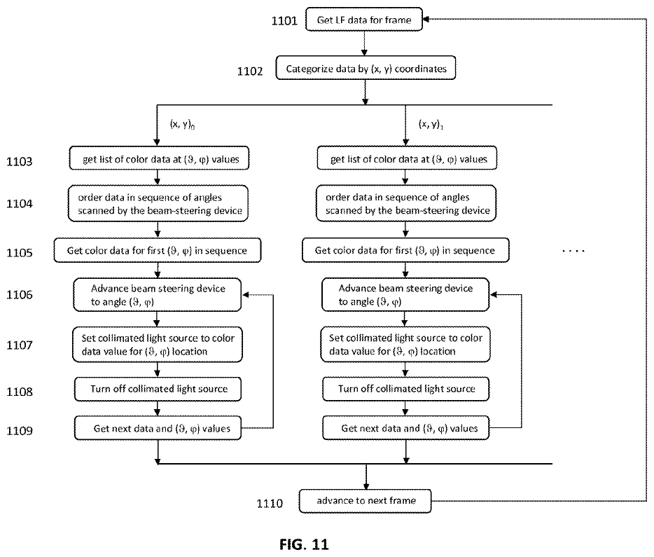

FIG. 11 comprises a flow diagram showing a method for determining the instruction for operating the energy source(s) and energy directing surfaces of the energy directing systems of the present disclosure. As shown in FIG. 3C, a controller may determine and provide instructions to an energy-directing system 3001 to refresh a scene of holographic objects within a refresh period of time by scanning each energy-directing site at location (x, y) in a sequence of angles (ϑ, φ) that may follow the most efficient raster scan ordering for the energy-directing device. The controller may also provide instructions to modulate one or more energy sources in synchronization with the configuration of the energy-directing device. For examiner, in an embodiment, each collimated light source may be switched to a state in which zero energy is output when the corresponding energy-directing surface is being reconfigured to change angle, or when the appropriate amount of energy has been delivered at a given angular position (ϑ, φ) for the intended brightness. The viewer 150, through the persistence of vision, will be able to observe the holographic objects if the frame refresh rate, collimated source brightness, number of angles achieved by the energy-directing device per refresh period, and density of energy propagating modules is sufficiently high.

FIG. 11 illustrates an embodiment in accordance with the above. The first step 1101 in FIG. 11 is receiving, at the controller, a data set comprising energy attribute data for a plurality of four-dimensional (“4D”) coordinates in a 4D coordinate system. The plurality of 4D coordinates may each comprise two spatial coordinates defining spatial locations of a plurality of energy directing surfaces in the 4D coordinate system. As discussed in various embodiments above, the plurality of energy directing surfaces are configured to each receive energy from one or more energy sources and direct the energy along a plurality of energy propagation paths therefrom. The plurality of 4D coordinates may each also comprise two angular coordinates defining the angular directions of the energy propagation paths from each energy directing surface.

In an embodiment, the energy attribute data in the data set may comprise at least one energy attribute selected from a group consist of: color, intensity, frequency, or amplitude. In an embodiment, the data set received by the controller may include light field data for a frame of holographic content that is to be displayed. For example, in an embodiment, the light field data may contain at least color data values describing the intensity of one or more colors for a plurality of four-dimensional light field coordinates (x, y, ϑ, φ).

A processor may next in step 1102 process the data set received by the controller into subsets of data, each subset of data comprising the energy attribute data for the two angular coordinates of the energy propagation paths having the same spatial coordinates in the 4D coordinate system, thereby categorize this data by (x, y) location. For example, in an embodiment, this may create a list of color data values for each of a plurality of angular coordinates (ϑ, φ) at every corresponding (x, y) location. In an embodiment, the processor processing the data set may be the controller or a separate processor.

Based on a first subset of data, first instructions for operating a first energy directing surface may be determined. In an embodiment, the instruction may comprise a sequence of directing energy along different energy propagation paths of the first energy directing surface, and the first subset of data comprises the energy attribute data for the angular coordinates of the energy propagation paths of the first energy directing surface. One the first instructions are determined, the first energy directing surface may be operated accordingly to direct energy in a time-sequential manner.

An example of the determination of the first instruction and operating the first energy directing surface accordingly is provided by steps 1103-1109 in FIG. 11. Steps 1103-1109 may occur in parallel at each (x, y) location in the energy-directing device, but these sequence of steps are shown only for two locations (x, y)₀ and (x, y)₁ for illustration purposes. At the next step 1103, each (x, y) location receives a list of color data and corresponding angular coordinates (ϑ, φ). At step 1104, the controller may order this list of color data for each (ϑ, φ) angular coordinate into a sequence which best resembles the sequence of angles that the energy-directing device may switch between in the fastest time. This may be essentially the same as a raster scan angle ordering for the energy-directing device. Next at step 1105, the controller retrieves the first (color, ϑ, φ) data and then 1106 advances the energy-directing device to the appropriate angle (ϑ, φ), perhaps waiting for until the energy-directing device has settled. Next 1107, the controller sets the collimated light source to the corresponding color data intensity value. For an energy-directing module, the step of 1106 may involve: turning on a light source in the corresponding energy-directing module to the correct color and intensity or duration of time at a fixed light intensity value; turning on a light source associated with the corresponding energy-directing site to the correct color value as well as intensity or duration of time at a fixed intensity value; opening a mechanical or electrooptical shutter such as an LC panel for a fixed time, holding the energy-directing device at the appropriate angle for the duration of time necessary to direct the proper amount of light energy incident on one side of the energy-directing surface to a path (x, y, ϑ, φ), as shown in FIG. 8B. The next step 1108 is to turn off the light source, which may involve adjusting the current or voltage of a light source, deflecting the energy-directing device away from the display area, or closing a mechanical or electrooptical shutter such as an LC panel. In the next step 1109, the controller retrieves the color data for the next (ϑ, φ) coordinate in the sequence, and repeats steps 1106-1109. Once each energy-directing device at each (x, y) location has been cycled through the entire sequence of (ϑ, φ) data values, the controller is free to advance to the next frame of holographic content to be displayed.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically, and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. In general, but subject to the preceding discussion, a numerical value herein that is modified by a word of approximation such as “about” may vary from the stated value by at least ±1, 2, 3, 4, 5, 6, 7, 10, 12 or 15%.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result. Words relating to relative position of elements such as “near,” “proximate to,” and “adjacent to” shall mean sufficiently close to have a material effect upon the respective system element interactions. Other words of approximation similarly refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature.

The term “or combinations thereof” as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

What is claimed is:

1. An energy directing system, comprising:
a plurality of energy sources;
a plurality of energy directing surfaces configured to each receive energy from at least one energy source of the plurality of energy sources and direct energy along a plurality of energy propagation paths therefrom;
a controller in communication with the plurality of energy sources and the plurality of energy directing surfaces, the controller operable to provide synchronized signals to the energy sources and the energy directing surfaces to selectively direct energy along different energy propagation paths;
wherein the plurality of energy directing surfaces are arranged such that the energy propagation paths from each energy directing surface are each defined by a four-dimensional coordinate, the four-dimensional coordinate comprising two spatial coordinates corresponding to a location of the respective energy directing surface and two angular coordinates defining the angular direction of the respective propagation path.

2. The energy directing system of claim 1, wherein at least one of the energy directing surfaces comprises one or more layers of metamaterials.

3. The energy directing system of claim 2, wherein the one or more layers of metamaterials is configured to transmit energy therethrough and onto the plurality of energy propagation paths of the at least one of the energy directing surfaces.

4. The energy directing system of claim 2, wherein the one or more layers of metamaterials is configured to reflect energy therefrom and onto the plurality of energy propagation paths of the at least one of the energy directing surfaces.

5. The energy directing system of claim 1, wherein at least one of the energy directing surfaces comprises at least one reflective surface operable to rotate about orthogonal axes.

6. The energy directing system of claim 5, wherein the at least one reflective surface comprises a microelectromechanical system (MEMS).

7. The energy directing system of claim 1, wherein the at least one energy source is configured to provide collimated energy.

8. The energy directing system of claim 1, wherein the at least one energy source is configured to provide modulated energy.

9. The energy directing system of claim 8, wherein the synchronized signals of the controller are configured to operate the energy sources and the energy directing surfaces to selectively direct modulated energy along different energy propagation paths

10. The energy directing system of claim 1, the system further comprising at least one energy beam modifying element positioned between at least one of the energy directing surfaces and the corresponding at least one energy source, the at least one energy beam modifying element comprising a beam expander or a prism.

11. The energy directing system of claim 1, the system further comprising at least one reflector positioned to direct energy to at least one of the energy directing surfaces from the corresponding at least one energy source.

12. The energy directing system of claim 1, wherein the at least one energy source comprises a point-like energy source, and the energy directing system further comprise at least one energy focusing element positioned to collimate the energy from the at least one energy source.

13. The energy directing system of claim 1, wherein the at least one energy source comprises a point-like energy source, and the energy directing surfaces are configured to collimate energy received from the respective at least one energy source.

14. The energy directing system of claim 1, wherein the energy propagation paths of each energy directing surface are grouped around an energy propagation axis that defines an axis of symmetry with respect to an angular range of the propagation paths of the respective energy directing surface; and wherein the energy propagation axis of at least one of the plurality of energy directing surfaces forms a non-zero deflection angle relative to a normal of the at least one of the plurality of energy directing surfaces.

15. The energy directing system of claim 1, wherein the plurality of energy directing surfaces are formed by transmissive reconfigurable sites defined in a substrate, and the plurality of energy sources are mounted on a first side of the substrate, and further wherein the transmissive reconfigurable sites are operable to transmit energy from the respective at least one energy source towards a second side of the substrate along the respective energy propagation paths of the energy directing surfaces.

16. The energy directing system of claim 15, wherein the plurality of energy sources are housed in modules mounted to the first side of the substrate thereby aligning the plurality of energy sources with respect to the transmissive reconfigurable sites.

17. The energy directing system of claim 15, wherein the plurality of energy sources are mounted on a common backplane layer aligned with the substrate.

18. The energy directing system of claim 17, wherein the plurality of energy sources and the common backplane layer are defined on a semiconductor substrate.

19. The energy directing system of claim 17, wherein the plurality of energy sources and the common backplane layer are defined on a printed circuit board.

20. The energy directing system of claim 17, wherein the plurality of energy sources are aligned with respect to the substrate such that each energy source substantially provides energy to only one of the transmissive reconfigurable sites.

21. The energy directing system of claim 20, further comprising energy inhibiting structures configured to substantially limit propagation of energy from one of the energy sources to more than one of the transmissive reconfigurable sites.

22. The energy directing system of claim 1, wherein the plurality of energy directing surfaces and the plurality of energy sources are housed in modular energy directing modules.

23. The energy directing system of claim 22, wherein each energy directing module comprises:
a substrate defining a transmissive reconfigurable site defined therein, the transmissive reconfigurable site forming one of the plurality of energy directing surfaces; and
the corresponding at least one energy source providing energy to the transmissive reconfigurable site.

24. The energy directing system of claim 23, wherein the energy directing modules are arranged to form an array of transmissive reconfigurable sites such that energy is operable to be directed from each transmissive reconfigurable site along the energy propagation paths, each energy propagation path having the respective four-dimensional coordinate.

25. The energy directing system of claim 22, wherein each energy directing module comprises:
a substrate defining transmissive reconfigurable sites defined therein, the transmissive reconfigurable sites forming a subset of the plurality of energy directing surfaces; and
a respective subset of the plurality of energy sources providing energy to the transmissive reconfigurable sites; and
energy inhibiting structures configured to substantially limit propagation of energy from each energy source to more than one transmissive reconfigurable sites.

26. The energy directing system of claim 22, further comprising a shutter posited in an energy path between at least one of the energy directing surfaces and the respective at least one energy source.

27. The energy directing system of claim 26, wherein the at least one of the energy directing surfaces is operable to direct energy along a first energy propagation path during a first time period and to direct energy along a second energy propagation path during a second time period, and wherein the controller is in electronic communication with the shutter and operable to synchronize an actuation of the shutter during a time period between the first and second time periods.

28. An energy directing system, comprising:
an energy source configured to provide collimated energy;
an array of energy directing surfaces each configured to receive the collimated energy and deflect the received energy along a plurality of energy propagation paths therefrom; and
a controller in communication with the energy directing surfaces, the controller operable to provide signals to the energy directing surfaces to selectively direct energy along different energy propagation paths;
wherein the plurality of energy directing surfaces are arranged in the array such that the energy propagation paths from each energy directing surface are each defined by a four-dimensional coordinate, the four-dimensional coordinate comprising two spatial coordinates corresponding to a location of the respective energy directing surface and two angular coordinates defining the angular direction of the respective propagation path.

29. The energy directing system of claim 28, wherein the signals of the controller cause at least one of the energy directing surfaces to reflect the received energy along a set of energy propagation paths in a sequence.

30. The energy directing system of claim 28, wherein at least one of the energy directing surfaces comprises one or more layers of metamaterials.

31. The energy directing system of claim 28, wherein the one or more layers of metamaterials is configured to reflect energy therefrom and onto the plurality of energy propagation paths of the at least one of the energy directing surfaces.

32. The energy directing system of claim 31, wherein the one or more layers of metamaterials is transmissive and configured to deflect energy that passes through the one or more layers therefrom and onto the plurality of energy propagation paths of the at least one of the energy directing surfaces.

33. The energy directing system of claim 28, wherein at least one of the energy directing surfaces comprises a reflective surface operable to rotate about orthogonal axes.

34. The energy directing system of claim 28, wherein the energy source comprises a point energy source at least one energy focusing element positioned to collimate energy from the point energy source.

35. The energy directing system of claim 28, wherein the energy propagation paths of each energy directing surface are grouped around an energy propagation axis that defines an axis of symmetry with respect to an angular range of the propagation paths of the respective energy directing surface; and wherein the energy propagation axis of at least one of the plurality of energy directing surfaces forms a non-zero deflection angle relative to a normal of the at least one of the plurality of energy directing surfaces.

36. The energy directing system of claim 28, wherein the plurality of energy directing surfaces are formed by reflective reconfigurable sites defined in a substrate.

37. The energy directing system of claim 28, wherein the plurality of energy directing surfaces are housed in modular energy directing modules.

38. The energy directing system of claim 37, wherein each energy directing module comprises a substrate defining a reflective reconfigurable site defined therein, the reflective reconfigurable site forming one of the plurality of energy directing surfaces.

39. The energy directing system of claim 38, wherein the energy directing modules are arranged to form an array of reflective reconfigurable sites such that energy is operable to be directed from each reflective reconfigurable site along the energy propagation paths, each energy propagation path having the respective four-dimensional coordinate.

40. The energy directing system of claim 28, further comprising a shutter posited in an energy path between at least one of the energy directing surfaces and the energy source.

41. The energy directing system of claim 40, wherein the at least one of the energy directing surfaces is operable to direct energy along a first energy propagation path during a first time period and to direct energy along a second energy propagation path during a second time period, and wherein the controller is in electronic communication with the shutter and operable to synchronize an actuation of the shutter during a time period between the first and second time periods.

42. The energy directing system of claim 28, wherein the energy source configured to provide collimated energy is modulated time sequentially.

43. The energy directing system of claim 42, wherein the energy source is modulated to switch between first and second states during different time periods, and wherein, in the first state of the first energy source, substantially zero collimated energy is provided to the array of energy directing surfaces, and in the second state of the energy source, non-zero collimated energy is provided to the array of energy directing surfaces.

44. The energy directing system of claim 43, wherein an operation of at least one energy directing surface is synchronized with a modulation of the energy source such that the at least one energy directing surface is reconfigured from directing energy along a first energy propagation path to directing energy along a second energy propagation path while the energy source is in the first state, the first and second energy propagation paths have different angular coordinates.

45. A method for directing energy according to a four-dimensional function, the method comprising:
receiving a data set comprising energy attribute data for a plurality of four-dimensional (“4D”) coordinates in a 4D coordinate system, the plurality of 4D coordinates each comprising:
two spatial coordinates defining spatial locations of a plurality of energy directing surfaces in the 4D coordinate system, the plurality of energy directing surfaces configured to each receive energy from one or more energy sources and direct the energy along a plurality of energy propagation paths therefrom; and
two angular coordinates defining the angular directions of the energy propagation paths from each energy directing surface;
processing the data set into subsets of data, each subset of data comprising the energy attribute data for the angular coordinates of the energy propagation paths having the same two spatial coordinates in the 4D coordinate system;
determining, based on a first subset of data, first instructions for operating a first energy directing surface, the instruction comprising a sequence of directing energy along different energy propagation paths of the first energy directing surface, the first subset of data comprising the energy attribute data for the two angular coordinates of the energy propagation paths of the first energy directing surface; and
operating the first energy directing surface to direct energy in a time-sequential manner according to the determined first instructions.

46. The method of claim 45, wherein the energy attribute data comprising at least one energy attribute selected from a group consisting of: color, intensity, frequency, and amplitude.

47. The method of claim 45, wherein the sequence of directing energy along different energy propagation paths of the first energy directing surface is determined to account for the efficiency of reconfiguring the first energy directing surface.

48. The method of claim 45, further comprising determining, based on the first subset of data, instructions for operating the one or more energy sources to direct modulated energy to the first energy directing surface in synchronization with the instructions for operating the first energy directing surface.

49. The method of claim 45, further comprising determining, based on a second subset of data, second instructions for operating a second energy directing surface, the second instructions comprising a sequence of directing energy along different energy propagation paths of the second energy directing surface, the second subset of data comprising the energy attribute data for the angular coordinates of the energy propagation paths of the second energy directing surface.

50. The method of claim 49, further comprising operating, simultaneously with operating the first energy directing surface, the second energy directing surface to direct energy in a time-sequential manner according to the determined second instructions.

51. The method of claim 45, wherein the sequence of directing energy along different energy propagation paths of the first energy directing surface is to be completed within a time period.
